(19) United States
(12) Patent Application Publication
(10) Pub. No.: US 2025/0258465 A1
(43) Pub. Date: Aug. 14, 2025

(54) TIME SERIES BASED MACHINE LEARNING FRAMEWORK FOR HARDWARE EQUIPMENT AND ITS IMPLEMENTATIONS WITH TRANSFORMERS AND ON OPTICAL PROGRAMMING PROCESSORS

(71) Applicant: Jing PAN, San Lorenzo, CA (US)

(72) Inventor: Jing PAN, San Lorenzo, CA (US)

(21) Appl. No.: 18/991,642

(22) Filed: Dec. 22, 2024

Related U.S. Application Data
(63) Continuation of application No. 18/440,875, filed on Feb. 13, 2024, now Pat. No. 12,174,598.

(51) Int. Cl. G05B 13/04; G05B 13/02

(52) U.S. Cl. CPC G05B 13/042; G05B 13/0265; G05B 13/048

(57) ABSTRACT

A method includes: obtaining equipment sensor data from sensors in a time series; obtaining equipment optimization goal data from optimization goals in a time series; obtaining historical data on equipment abnormal events and intervention events; obtaining static equipment input parameters; applying time series model to the equipment sensor and optimization data, historical event data, and static equipment input parameters, to obtain predicted equipment sensor data; optimizing and controlling hardware operation based on the obtained predicted equipment sensor data; and providing predicted actions for abnormal event intervention based on the obtained predicted equipment sensor data. Hardware control, with optical mechanisms, into deep space, with a novel blockchained quantum bit communication network can be included, as changes to existing applications of transformer models, including ring-all reduced training on top of data and model parallelism, novel graph modalities, generic chart generations, generated image enabled search and drop ship, and multi-modal car foundation models.

### CROSS-REFERENCE TO RELATED APPLICATION

This is a continuation of U.S. patent application Ser. No. 18/440,875 filed on Feb. 13, 2024 (now U.S. Pat. No. 12,174,598 issued on Dec. 24, 2024), the disclosure of which is hereby incorporated by reference in its entirety.

### BACKGROUND

Hardware equipment such as assembly lines in manufacturing, electric power systems, building heating, ventilation and air conditioning (HVAC) is typically controlled by computer processors running program, with feedback of data from sensors distributed in the hardware equipment system.

### SUMMARY

A method for controlling hardware includes: obtaining equipment sensor data from a plurality of sensors in a time series; obtaining equipment optimization goal data from a plurality of optimization goals in a time series; and obtaining historical data on equipment abnormal events and intervention events.

In some embodiments, the first and second time series can be combined into at least one multi target time series. In some other embodiments, the first and second time series are different time series.

In some embodiments, the method further includes: obtaining static equipment input parameters; applying time series models to the equipment sensor data, the historical data, and the static equipment input parameters, to obtain predicted equipment sensor data in the time series; and in some embodiment, optimizing the manufacturing based on the predicted equipment optimization goal data; and in other embodiment ensuring hardware equipment operates normally based on predicted abnormal event data; and providing predicted actions for predicted abnormal event intervention based on action recommendation data.

In some embodiments, the method further includes: iterating at least once between said obtaining historical data on equipment abnormal events and intervention events, said obtaining static equipment input parameters, and said applying the time series model to the equipment sensor data, the historical data, and the static equipment input parameters, to obtain the predicted equipment sensor data, the optimization goal values, and the predicted abnormal events; and providing the predicted actions and the evaluated actions based on results from said iterating.

In some embodiments, the providing includes displaying the results on a display screen or phone alert to a user.

In some embodiments, the providing comprises sending a control signal based on the results to a control circuit for controlling the hardware to realize manufacturing optimizing.

In some embodiments, the time series model includes a transformer model, i.e., the foundation model.

In some embodiments, the method further includes outputting a plurality of y variables from the time series model, including equipment sensor data y_(si-t), from i-th sensor data as a function of time t. Optionally, the sensor data y_(si-t) includes temperature data measured at specified locations. Optionally, the equipment sensor data y_(si-t) includes electric motors' amplitude, voltage, current, frequency, force, etc.

In some embodiments, the method further includes outputting a plurality of y variables from the time series model, including equipment optimization goal data y_(oj-t), from j-th optimization goal data as a function of time t.

In some embodiments, the equipment optimization data y_(oj-t) includes electric motors' energy output, power, torque (sometimes can also be measured as y_(si-t)), energy efficiency, etc.

In some embodiments, the machine learning architecture at least stack two layers of models on top of the input time series data.

Optionally, the machine learning architecture stacks three layers of models on top of the input time series data.

Optionally, the machine learning service is based on at least two layers of model architecture.

Optionally, the machine learning service is based on three layers of model architecture.

In some embodiments, a method is provided to generate target value sequence beyond one time stamp ahead, and use this generated target value sequence for models in downstream layers as input when real data is not available, wherein abnormal event models predict abnormal events far into the future because the previous layers are capable to predict sensory data far into future and choice of survival classifier enables manipulation of historical abnormal event data by rows to overcome the lesser abnormal event label in a supervised learning concept.

In some embodiments, an abnormal event model based on transformer is capable to forecast predicted abnormal events.

Optionally, an abnormal event model based on transformer is capable to forecast predicted abnormal events when there is no previous historical abnormal event.

Optionally, an abnormal event model based on transformer is capable to forecast predicted abnormal events when there is only one previous historical abnormal event.

Optionally, an abnormal event model based on transformer is capable to forecast predicted abnormal events when there are several historical abnormal events.

In some embodiments, action recommendation models can output predicted actions far into the future because the previous layers are capable to predict sensory data far into future.

Optionally, the action recommendation models can output predicted actions far into the future with supervised learning methods from the recommendation system.

Optionally, the action recommendation models can output predicted actions far into the future with multi class binary classification models.

Optionally, the action recommendation models can output predicted actions far into the future with the graph link formation prediction approach.

In some embodiments, the action recommendation models can output predicted actions far into the future from the transformer model.

Optionally, the action recommendation models can output predicted actions far into the future from the transformer model with the multi modal approach.

Optionally, the action recommendation models can output predicted actions far into the future from the transformer model with an action evaluation approach.

In some embodiments, the method for controlling hardware provides hardware equipment parameter optimization based on time series models, wherein the optimization models predict optimization goal values. The hardware parameters in the input of those models that yield the best optimization goal values are the best hardware parameter set.

Optionally, more efficient parameter search methods for hardware equipment parameters are machine learning based search methods.

Optionally, more efficient parameter search methods for hardware equipment parameters are machine learning based search methods such as random and SAMBO.

In some embodiments, a hardware control system is provided that executes optimization strategies and predicted abnormal event interventions by adjusting equipment operating parameters based on layered machine learning models.

Optionally, the system includes an application service that compares input signals from layered machine learning models with current hardware states and generates executable software control signals.

Optionally, these software control signals are translated into hardware control signals to alter equipment operations, enabling adjustments in response to predictive insights.

Optionally, the system operates in dual modes-autonomous and human-in-the-loop—where human operation takes precedence over autonomous control, allowing direct human intervention when necessary.

In some embodiments, hardware equipment parameter optimization is based on transformer.

In some embodiments, hardware equipment control based on time series machine learning models or transformer, and a novel numerical approach without explicit formula are provided.

In some embodiments, a large transformer model (a foundation model) is provided, which learns and organizes a lot of hardware equipment data from various application scenarios and types of equipment and various input and output data types and sources, serves as a foundation model similar to that of Large Language Model (LLM), to generate sequences of all kinds of sensory, optimization, abnormal event, action sequence, sequence prediction, task specific prediction, fine tuning, transfer learning, embedding, retrieval, and so on.

In some embodiments, the method for controlling hardware provides an EquiFormer system design based on the concept of connected equipment, wherein the Equiformer system is applied to the remotely configurable and programmable optical programming processor (RCP_OPP); wherein the RCP_OPP design is based on Internet of Things (IoT) component assuming internet connections; wherein the design solution for the RCP_OPP to be integrated into a larger system to control equipment in a deep space is based on photon entanglement assuming no internet connections, or a photon controlled optical programming processor (PC_OPP); wherein the PC_OPP's control on photon entanglement is from Earth to deep space.

In another aspect, a non-transitory computer-readable medium is provided, having instructions stored thereon for execution by one or more processing circuits to implement operations of the methods for controlling hardware.

In yet another aspect, a manufacturing system is provided, including one or more processing circuits, a manufacturing/assembly line, sensors, controllers, and the non-transitory computer-readable medium for optimization of the manufacturing process.

In some embodiments, three methods are provided for converting hardware input parameters to photon output parameters, enabling communication and control over long distances, such as to deep space.

In one embodiment, hardware parameter values are mapped to laser light wave parameters. A powerful laser source with precision aiming capabilities transmits these mapped laser signals directly from Earth to distant space locations. Receivers in space convert the laser light wave parameters back into signals to control hardware in a PC_OPP configured to this method.

In another embodiment, photon-based quantum teleportation of continuous variables is utilized. Continuous amplitude and phase quadratures of the light field serve as information carriers. Entangled states and classical communication are employed to transfer unknown quantum states from a sender to a receiver, enabling the transmission of hardware parameter values encoded in continuous variables.

In yet another embodiment, photon-based quantum bit encoding is employed. Hardware parameter values are converted into binary form and mapped onto quantum bits using the quantum states of photons. A novel blockchained quantum bit communication network is proposed, wherein photons' quantum states are transmitted through a network of nodes, similar to blocks in a blockchain. This method enhances security and error correction without reliance on classical communication methods. The blockchained quantum bit communication network is uniquely proposed by the inventor.

Optionally, the blockchained quantum bit communication network involves multiple nodes receiving quantum bit encoded information from a sender. These nodes compare and verify the received information locally, using majority consensus to correct errors and detect tampering, thus eliminating the need for classical communication for error correction.

The blockchained quantum bit communication network serves as a generic mechanism for quantum bit communication, not limited to hardware control.

Optionally, the PC_OPP can be replaced with other mechanisms near the hardware equipment if preferred after the hardware parameters are communicated to deep space through the three proposed methods.

In some embodiments, a method is provided for training deep learning models including transformer models using ring-all reduce gradient updates on top of both model and data parallelism, enhancing training scalability without relying on centralized parameter servers.

In one embodiment, the ring-all reduce technique is applied to gradient averaging in a peer-to-peer manner among computation units when both data parallelism and model parallelism are utilized. This allows efficient synchronization of gradients corresponding to the same partition of the model but computed from different data batches.

Optionally, this method supports partitioning matrices in low-rank adaptation (LoRA) across different computation units, applying ring-all reduce to synchronize gradients for LoRA fine-tuning.

In some embodiments, a generic solution is provided for generating 2D or 3D visual charts using a hybrid large language model via a common language representation, and optionally a graph representation.

In one embodiment, visual charts are translated into a common language representation where visual elements are defined with properties like type, color, location, and relationships. These representations are used to fine-tune existing large language models to generate visual charts.

In another embodiment, visual elements are encoded as tokens with corresponding embeddings, and sequences of visual elements are organized based on their relationships described by graphs.

Yet in another embodiment, a hybrid model architecture is proposed that includes a language modality and a visual graph modality. The model utilizes transformer-based modules for each modality and incorporates fusion layers with cross-modal attention to generate visual charts.

Optionally, mechanisms are provided to validate the generated representations to ensure they form legitimate visual charts, and further human or model-based feedback is used to improve the generation quality.

In some embodiments, a graph modality enabled generation method is proposed, which allows transformer-based models to generate sequences of vertex IDs based on graph paths, enabling richer connectivity among tokens than sequential approaches.

Optionally, the method is applied to generate action sequences for AI agents, recommendation systems, and visual chart generation, where the relationships among items are represented by graphs rather than just sequences.

In some embodiments, a picture generation enabled search and drop-ship system is provided, enhancing product discovery and shopping experiences.

In one embodiment, images are analyzed to recognize properties using models like convolutional neural networks, and a multi-modal large model generates product images based on user natural language queries combining images with specific properties.

Optionally, image-to-image search is performed based on image similarities to find matching products, even when existing natural language descriptions of images lack the queried properties, and a drop-ship service is offered if matching products are not found.

In some embodiments, an EquiFormer-incorporated multi-modal car foundation model is proposed, which includes modules for hardware equipment, human behavior, energy management, and other aspects, utilizing a structure similar to multi-modal models with fusion layers. The multi-modal car foundation model facilitates interaction with human drivers, pedestrians, and other entities, enhancing autonomous driving systems.

Optionally, the hardware module incorporates the EquiFormer model structure as a backbone, allowing for advanced forecasting and control of car systems.

Optionally, the model includes sub-modules for different types of vehicles, such as internal combustion engine vehicles, hybrid vehicles, and electric vehicles, and can integrate various input services like weather, traffic, and road conditions.

### BRIEF DESCRIPTION OF THE DRAWINGS

FIG. 1 shows an EquiFormer overall system design with machine learning service.

FIG. 2 shows an EquiFormer general machine learning architecture.

FIG. 3 shows EquiFormer sensory models generating predicted target value sequence.

FIG. 4 shows an EquiFormer IoT and cloud machine learning services.

FIG. 5 shows a survival classifier based abnormal event model.

FIG. 6 shows an action recommendation with a recommendation system-based model.

FIG. 7 shows an action recommendation with a graph link formation prediction.

FIG. 8 shows a transformer-based hardware optimization model architecture.

FIG. 9 shows a transformer embedding retrieval-based hardware input optimization.

FIG. 10 shows an embedding based approach to predict abnormal events when historical abnormal event happened only once.

FIG. 11 illustrates a conceptual diagram of the hardware components of the remotely configurable and programmable optical programming processors (RPC_OPP), but not specific exact electrical diagram.

FIG. 12 shows a photon entanglement-based optical programming processor (PC_OPP) control system.

FIG. 13 shows a blockchained quantum bit communication network.

FIG. 14 illustrates a ring-all reduce gradient update for a deep learning model on top of both data and model parallelism.

FIG. 15 shows model partitioning for low-rank adaptation.

FIG. 16 shows the correspondence of model partitions and low rank matrices A and B partitions.

FIG. 17 illustrates dural ring-all reduce operations for low-rank adaptation fine tuning on top of both data and model parallelism.

FIG. 18 illustrates a generic visual chart generation.

FIG. 19 shows a car multi modal modularized foundation model.

### DETAILED DESCRIPTION

### Section 1. Introduction

Hardware equipment operate in a fashion that they have a large quantities of fast changing time series data from different sensors in almost real time, have relatively less fast paced changing parameters pre-set/tuned for equipment, and have multiple non-mutually exclusive events such as maintenance, failures, adjustments, and production, and multiple optimization goals such as best energy efficiency, maximum product output, and less failures. The complexity of the hardware system makes it hard to be optimized with traditional machine learning methods.

A supervised learning modeling technique typically needs labels. In time series problem, it needs dependent variable(s) that change(s) with time. However, other than the sensor data which is also the modeling input, usually the optimization goal for manufacturing, such as the production output rate etc. does not change that much in real data. For events such as maintenance and failures, they are extremely rare in real data. That is why it is generally difficult to apply machine learning techniques to model hardware system in manufacturing process, power system, HVAC system, etc.

Artificial intelligence (AI) has made progresses in natural language processing (NLP) and imaging/video processing. Hardware and manufacturing industry, however, has yet seen major changes by AI. The reasons can include: (1) events, especially abnormal events or intervention actions (such as maintenance), in manufacturing industry occur rarely, which is difficult for supervised learning technique to use those rare events as labels; and (2) it is difficult to model large quantities of time series data from equipment sensors with traditional time series models with limited variability in both dependent and input variables, long sequences in sensory data, multiple dependent variables, multiple inter-correlated modeling goals, collinearity of input variables, lack of integrated data source across the industry (as compared to internet data on the cloud) due to lack of secure hardware infrastructure with internet of things (IoT) and integration with cloud data platform, etc.

In some implementations, traditional time series techniques can be employed to model manufacturing equipment data, for example, based on regression-based time series (Mendenhall, Sincich et al. 2003). This regression approach usually models one time series sequence at a time. Manufacturing equipment, however, usually have a large number of sensors for even one equipment/processors, and one senor might also sense more than one dimension of data. People would want to know all of the future sensory values, which requires modeling many time series sequences, and dealing with long sequences in sensory data, multiple dependent variables, multiple inter-correlated modeling goals, collinearity of input variables.

Another approach can be a tree-based model (Liukis 2020). Usually, it also only models one time series sequence at a time. It is best suitable, among traditional machine learning methods, to model multiple mutually exclusive categorical classifications as dependent variables with time component in the modeling input. In a manufacturing process, many of the future target values of interest are either correlated, or categorical but not mutually exclusive. For example, a hardware component of an equipment's temperature when in use might be correlated with the volume of the component. In another example, a component of an equipment in use can have deficiency in one area as the component ages, which also increase its chance of having a deficiency in another area. It could potentially model continuous dependent variables but it lacks the capacity to modeling complex correlations and variability among both dependent and independent variables.

Deep learning with its unique ability to predict non-mutually exclusive multi label output, with universal approximation, meaning any relation among dependent and independent variables, is the next advance for modeling manufacturing process. Transformer is a type of deep learning model that models long sequences (Vaswani, Shazeer et al. 2017). It has traditionally been applied to natural language processing and imaging processing with a lot of breakthroughs. For example, a first step of a large language model is a pre-trained transformer model on language corpse. However, machine learning modeling techniques have been difficult to be applied to the hardware system in manufacturing process, etc. for (1) lack of a large quantity of integrated data source and IoT/cloud system design on how to achieve this goal; (2) lack of hardware design to achieve such system design in (1), especially when there is a long distance from sensor to data center or no internet is available, etc.; (2) lack of hardware system's specific time series coding for sequences in the modeling; (3) lack of design of model stacking/model architecture with multiple goals (4) non-existence of transformer based task specific machine learning solutions for hardware system's specific application scenarios when there are plenty for NLP and imaging. In the hardware optimization part of the goal, traditional control theory relies on explicitly written out mathematical formulas to achieve optimal parameters. Either the mathematical formulas deviate from the reality or the real data is hard to be approximated with explicit formulas. It is hard to apply existing control theory to those parameters to correct deviation of the parameter values even if the optimal parameters are known to machine learning optimization models.

### Section 2

The following paragraphs describes a system framework according to some implementations of this disclosure.

### Section 2.1. System Design

The machine learning service part can include: (1) a pre-trained machine learning model of historical time series data, (2) a simulation-based approach from pre-trained model to update parameters for optimization goal, (3) a continuous online model update, (4) continuous parameter optimization based on real-time equipment data, and (5) multi-modal model-based events prediction and action evocation. In addition to the machine learning service, hardware system, and software service essential for the machine learning service to function are also needed.

For example, an air conditioner for cooling may have the following non-time-stamped input: designed alternating current (AC) voltage intake, designed AC amperage intake, product dimensions, designed power consumption, weight; time stamped sensory data: room temperature, room humidity, room O₂ level, room CO₂ level, room air pressure, outside temperature, real-time AC power, real-time motor frequency, real-time motor torque, real-time motor temperature, indoor airflow rate, etc.; optimization goal: SEER (Seasonal energy efficiency ratio), cooling capacity measured in British Thermal Units (BTUs); and example of abnormal events: motor failure, electric circuit failure.

Section 2.2. Machine Learning Design with Time Series

In the above system design, the machine learning service is backed by layers of machine learning models. To begin with, parts (1) and (3) will have very similar machine learning model architecture based on time series. That is “layer one” of machine learning architecture according to some embodiments of the present disclosure.

First, time t can be defined as a series of temporal points from 0 to n.

Second, multiple y variables can be designated to represent the output/target of the models. (1) In some embodiments, equipment sensor data y_(si-t) can be obtained, in which i is the i-th sensor data that is from equipment and changes with time t. An example can be the temperature T at a particular spatial location at a particular time t on the equipment. (2) In some embodiments, continuous equipment optimization goals y_(oj-t) can be obtained, in which j is the j-th equipment optimization goal's value, and changes with time t. An example can be the manufacturing output rate at a particular time. (3) In some embodiments, binary equipment abnormal event y_(ek-t) can be obtained, in which k is the k-th equipment-related abnormal event and it can only take the value of 0 indicating that the event does not happen, or the value of 1 indicating that the event happens.

In real data, occurrences of 1 can be very rare, such as in the event of a hardware failure, a hardware alarm, etc.

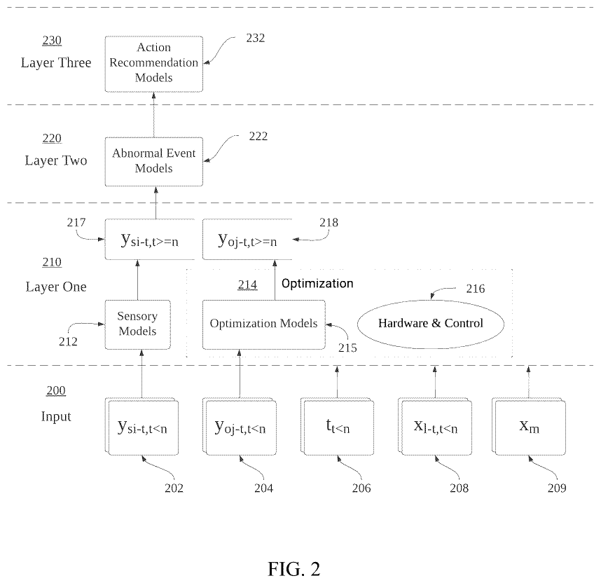

Third, the model can be fed with input data (200). FIG. 2 illustrate the overall machine learning architecture from input data to model layer stacking. (1) In a first example, time step itself t_(t<n) 206, can be input. (2) Other input variables such as sensory data y_(si-t, t<n) 202 and optimization goal y_(oj-t, t<n) 204, can also be included. Time series' characteristics can be that for y variable at t=n, all of its previous values at ten can be used as input. (3) In a third example, time-based other input variables x_(l-t, t<n) 208 can be provided. Examples include the temperatures from weather forecast service. (4) In a fourth example, none-time-based other input variables x_m 209 can be provided. Examples include the equipment's design specifications, such as designed coil diameter, equipment designed voltage intake, etc. Input variables in the x_m group do not change with time, and not all time series models require every input variable to change with time, but are generally kept in the model's general form. Input variables in the x_m group differ when there are many different similar hardware machines being modeled in one machine learning time series model. Input variables in the x_m group are extremely useful when applying transformer modeling technique to a large amount of similar but different hardware machines like large language corpses providing invaluable baseline information.

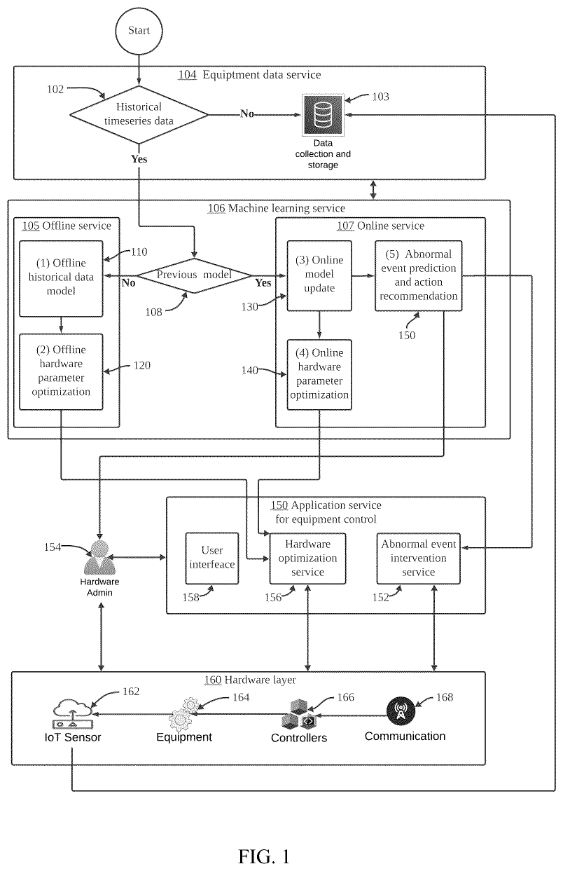

FIG. 1 illustrates an EquiFormer overall system design with machine learning service. In the equipment data service 104, the system first determines whether historical time series data are available for a specific use case at step 102. If they are not available, then equipment data collection and storage component 103 can be invoked. Data from the equipment data service 104 can be exchanged with machine learning service 106, specifically to a determining step 108 on whether previous model exists. If not, then offline historical data model 110 can be invoked, to provide offline hardware parameter optimization 120. If previous model 108 does exist, then online model update 130 can be invoked, which facilitates online hardware parameter optimization 140, as well as task-specific abnormal event prediction and action recommendation 150.

Both human hardware administrators 154 and an application service for equipment control 150 operate independently and, optionally, in parallel to manage the hardware layer 160. Human hardware administrators 154 and the application service 150 exchange information and control instructions bidirectionally via user interfaces 158, which include visual/audio/haptic signals, touch screens, keyboards, and phone/tablet alerts or applications as components of the application service 150. The application service 150 receives input from the machine learning service 106 and hardware layer 160, and generates software-based control signals for the hardware layer 160. The application service 150 comprises two functional components: a hardware optimization service 156 and an abnormal event intervention service 152.

The hardware optimization service 156 accepts input from static or dynamic optimal parameters provided by the offline 120 or online 140 hardware parameter optimization components. It autonomously exchanges information and control signals with the hardware layer 160 and optionally interacts with the human hardware administrator 154. Predictions of abnormal events and recommended actions from the online hardware parameter optimization 140 can be displayed on the user interface 158, via the abnormal event intervention service 152, as visual information or transmitted through other audio/visual/haptic signals as abnormal event alerts. These alerts inform the human hardware administrator 154. Since abnormal event intervention is critical, the human hardware administrator can directly interact with the hardware layer 160 to perform mission-critical actions. They can also bypass the application service 150 and directly take input from the abnormal event prediction and action recommendation component 150, making independent judgments without requiring input from the services 106 and 150.

The human hardware administrator 154 can intervene in the equipment 160 either directly or through a controller 166 via the user interfaces 158. The hardware optimization service 156 and the abnormal event intervention service can automatically control the equipment 165 through controllers 166. Optionally, the human hardware administrator 154 can modify the input to the controllers 166 through the user interface 158 in the application service 150. The controllers 166 process software-generated control signals and convert them into physical signals, such as light wave amplitudes, which the equipment 165 interprets to adjust its operational state.

The application service 150 interfaces with the controllers 166 either via a direct physical connection, such as through a USB-C port or connector block, which allows the software to communicate directly with the controller without intermediary communication components, or optionally via a communication component 168. This communication component relays software control signals over longer distances, which cannot be achieved through a direct physical connection.

The Internet of Things (IoT) sensors 162 in the hardware system 160 gather data from equipment 164 and transmit this data to the data collection and storage component 104. The IoT sensors 162 also provide real-time feedback to both the human hardware administrator 154 and the application service for equipment control 150, enabling iterative adjustments to the control signals provided to the hardware layer 160. For example, an input control signal to the hardware layer might specify “increase the speed to x revolutions per minute.” However, after some time, the motor speed may plateau at x minus delta revolutions per minute. In such scenarios, the application service 150 can optionally send updated control signals to the hardware layer 160 without relying on the computationally expensive equipment data service 104 and machine learning service 105.

EquiFormer's machine learning architecture serves as underlying architecture of the system (FIG. 1) and stacks three layers of models. The overall machine learning architecture is depicted in FIG. 2. In layer one 210, there are two categories of models, sensory models 212 and optimization models 215 to model time series data whose output are predicted sensory values 217 and optimization values 218, respectively, and optimization strategyies 214 build on top of optimization models 215 and hardware control strategies 216 as a sub-component of optimization strategies. In layer two 220, there are abnormal event models 222. In layer three 230, there are action recommendation models 232. Each upper layer is built with input from previous layer(s)'s output. Sensory 212 and optimization 214 models in FIG. 2 back up 110 and 130 in FIG. 1. Hardware optimization 214 and control 216 in FIG. 2 backs up 120 and 140 in FIG. 2. Abnormal event models 222 in FIG. 2 and action recommendation models 232 in FIG. 2 back up 150 in FIG. 1.

However, although this illustration FIG. 2 organizes the model stacking into three layers, the actual organization of model stacking remains flexible. Complex machine learning designs such as EquiFormer may require multiple layers of model stacking, enabling flexibility in predicting into the future and allowing for the separation or unification of multiple target variables into multiple models or a single model. Some machine learning techniques, such as transformer-based foundation models, are capable of generating any predicted sequences, including but not limited to sensory values, optimization goals, abnormal events, and actions. As a result, the three layers of models in FIG. 2 are compressed into the foundation models, exemplifying the flexibility of the model stacking organization. Nevertheless, this disclosure emphasizes the importance of the sensory models 212 depicted in FIG. 2, which predict sensory values when real sensory data is unavailable and predicted values are needed as inputs for subsequent models. In certain embodiments, the sensory models may reside in a separate layer 220 in FIG. 2 or be integrated into the transformer-based foundation models. In other embodiments, when real sensory values are available as direct input to models in layers two or three or both, models in layers two or three or both can disregard the output of the sensory models. However, the sensory models themselves are retained, as they remain essential for scenarios where real sensory values are not accessible.

Using industrial robot as an example, the measured non-time stamped specifications may include designed voltage and amperage intake, arm reach and payload capacity, degrees of freedom (joint flexibility), physical dimensions and weight, and type of controller and programming interface. The time-Stamped Sensory Data may include joint position and speed, load on each joint or end effector, motor temperatures, energy consumption in real-time, environmental temperature and humidity (if applicable), and vibration and acoustic signals. The optimization goals may include operational efficiency (speed and accuracy of movement), energy efficiency, minimizing wear and tear, and maximizing uptime and reliability. The abnormal events may include mechanical joint failures, overheating of motors or electronics, calibration drift, unexpected collisions or obstructions, and software or control system errors.

### Section 2.3. Time Series Models for Sensory Data and Hardware Optimization

Some embodiments of the present disclosure model the following time series relationships. (1) The machine learning model uses previous time's data t<n, with input of time t_(t<n), all of x_(l-t,t<n), all of y_(si-t,t<n) and all of x_m, and predicts the ith sensory data y_(si-t,t=n), at time t=n. It is called the sensory model. (2) The machine learning model uses previous time's data ten, with input of time t_(tn), all of x_(l-t,t<n), all of y_(si-t,t<n), additionally all of y_(oj-t,t<n), and all of x_m, and predicts the jth optimization goal y_(oj-t,t=n) at time t. It is called the optimization model.

In the sensory model, there are i output variables at time t=n. In some embodiments of the present disclosure, the choice of time series model is flexible. Various embodiments of the present disclosure can have different types of time series model to represent those relationship.

In addition, some embodiments of the present disclosure can choose times series models that have only one output variable per model; as such, i models are built. Alternatively, some embodiments of the present disclosure can skip i models, because one deep learning model can have i multiple head (i output variables). In some embodiments of the present disclosure, the system is designed without picking the specific model. So does the optimization model. For example, it is not necessarily to have j models, as long as the modeling technique predict j output variables.

Once sensory and optimization models are constructed, whether the choice of model technique is traditional time series techniques or new deep learning technique such as a transformer, the models can generate not only the target value at time t=n, but also at time t=n+1, n+2, . . . , n+time_delta, for both y_(si-t) and y_(oj-t). This is based on traditional or deep-learning-based generative AI.

Although other time series techniques are also capable of generating such sequence, they have not been widely applied to manufacturing equipment data, possibly because (1) such none-deep learning none-transformer generated sequence deviates from real data in manufacturing equipment which is in term due to (2) lack of capacity to model long sequence of data in the input and (3) incapacity of modeling collinearity in the multiple input and inter-correlation of multiple output.

For example, in case of abnormality detection, traditional statistical methods such as z-score only need 1 data point to test if that data point is deviant from population metric such as mean. Those skilled in the art typically feel if they have one target data point at time t, it is sufficient for them to make decisions such as sending alert.

For optimization goals, persons skilled in the art tend not to use sequence modeling techniques but tend to compress the time dimension to simplify model process.

In various embodiments of the present disclosure, traditional time series technique can be employed to generate sequence of manufacturing equipment data, and subsequently the generated sequence can be used as input for abnormal event models and action recommendation models for prediction. The time series sequence modeling, however, can be improved with novel transformer-based modeling techniques.

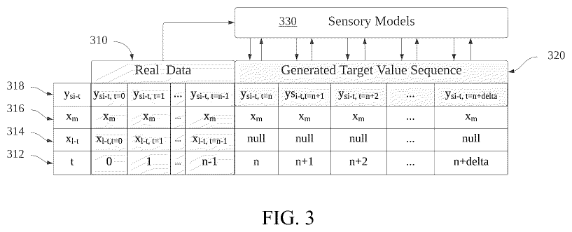

The method to generate target value at time beyond t=n, for example, at time t=n−1 is to recursively feed the next predicted target value to the model as shown in FIG. 3. FIG. 3 describes this generated sequence graphically in the example of sensory models. For example, at time t=n−1, persons skilled in the art get predicted value of y_(si-t,t=n) at time t=n by feeding real data 310 into the sensory models 330. In the next iteration, the predicted y_(si-t,t=n) is treated as if it were actual sensory data at time t=n, and feed into the sensory models to get the predicted value of y_(si-t,t=n+1), for time t=n+1, even though it still at time t=n−1, and those skilled in the art do not know the real value of y_(si-t,t=n) yet. If one of x_(l-t,t=n) at time n is unknown when the actual time is n−1, those skilled in the art can use their best guesses, for example, if this is foretasted temperature from weather service, one can use the next however many day's forecast, or just treat it as a missing data point in traditional machine learning, and fill with historical values such as mean, max, minimum, etc. By keeping repeating this process for the next predicted time step, persons skilled in the art will get a sequence of the predicted value of y_(si-t,t=n), y_(si-t,t=n+1), y_(si-t,t=n+2), and so on. This sequence 320 is a machine learning model generated sequence of sensory values. The process is similar to that for optimization models to generate optimization goal sequence: just need to add sensory model predicted values of y_(si-t,t>=n) as input to the optimization models.

In modern machine learning service practice, persons skilled in the art or automated processes will have to collect initial data for initial model training, which is the 110 in FIG. 1. As time goes by, more data will be collected and models will be updated, which is the 130 in FIG. 1. That is why the same sensory and optimization models are in two places in FIG. 1. The online model update part (130 in FIG. 1) is widely used in many online internet services such as online advertising, video site, social media and eCommerce. However, the online model update part is actually less frequent in the manufacturing industry. Before the internet of things happen in the industry, it is relatively hard to control a hardware from remotely online (cloud). Even after the internet of things appears, hardware control from remotely online is mostly rule based or human manual action. Various innovative aspects of some embodiments of the present disclosure compared with other approaches will be further described section 2.9.

### Section 2.4. Service Layers

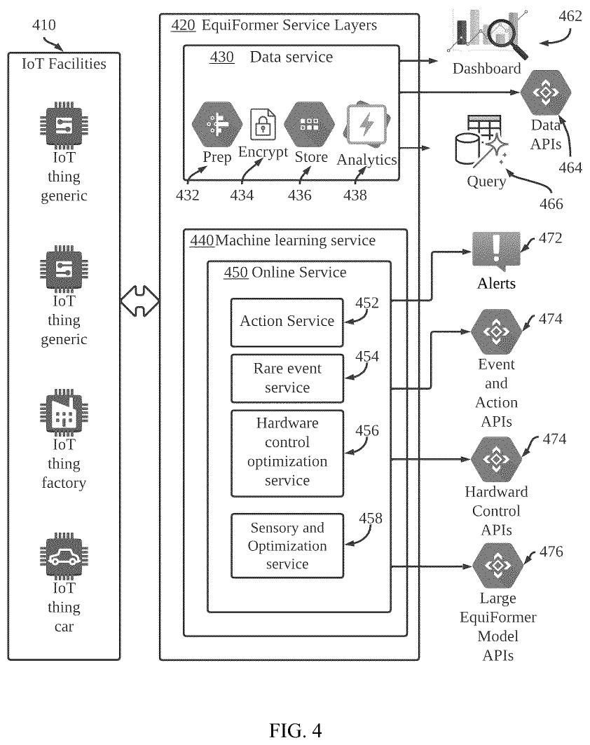

In order to make use of the EquiFormer system in FIG. 1, the online service layers depicted in FIG. 4 can be the application layer of EquiFormer system. The description of service layers is described after model layer one in Section 2.4. for ease of the audience to understand.

The service layers 420 utilize IoT facilities 410 instead of isolated equipment data collection as explained in Section 2.4., a large number of different hardware equipment provide more information in the x_m 209 group of inputs, and models of relationship between input and output from a large number of equipment provide baseline or large model information for specific piece of equipment to use via the service layers. It uses a lot of equipment connected through IoT to a larger model (EquiFormer), and use the large model to generate content (sensory and minimization sequence) for specific input (specific piece of equipment). The source of IoT equipment and facilities can be diverse, from manufacturing facilities, power systems, traffic systems, cars, building surveillance system, security system to anything. FIG. 4 only illustrates some examples of IoT equipment. However, this is not limiting of the present disclosure. The kind of sensory information and sensors can also be very diverse and for simplicity not depicted in FIG. 4.

The data service 430 first serves as a key component to provides data for modeling service. It prepares data 432, encrypts data 434 as security is always extremely important, stores data 436, and analyzes data 438, within itself. The sub components of the data service 430 are not limited to the said examples (432, 434, 436,438). Appropriate data related sub components can also be included. It also provides its own utilities through including but not limited to dashboards 462, APIs 464, queries 466, . . . , and so on.

The machine learning service 440 in FIG. 4 corresponding to 106 in FIG. 1, especially the online machine learning service 450 in FIG. 4 corresponding to 107 in FIG. 1, provides utilities with its sub services. Action service 452 and abnormal event service 454 send alerts and provides APIs. Some examples of the API usage could be but not limited to: (a) to control hardware equipment in case of predicted abnormal events and recommendation (b) to provide feedback and data back to machine learning and data services. Hardware control optimization service 456 not only figures out and continuously updates what best hardware parameters are, but also more importantly when hardware parameters are deviated from the optimal parameters, it calculates what the correction should be and provides APIs to continuously control the hardware to minimize the deviation. Sensory and optimization service 458 in FIG. 4 are based on sequence modeling in 212 and 215 in FIG. 2. It may not be obvious that they need to provide utility service on their own other than provide predicted data for downstream services (meaning 456, 454, 452). But they do. They can provide APIs, called Large EquiFormer Model APIs 476, for looking into the model, embeddings, model parameters, model weights, embedding comparisons, model update and fine tuning, etc. A description of embedding is further provided below.

A common practice in modern software architecture is modular and based on micro service. Only limited examples of APIs and services are depicted in FIG. 4. In reality, persons skilled in the art can always expand APIs, adding more services when appropriate. Also only limited sub components of services are depicted in FIG. 4. In reality, persons skilled in the art can always expand, separate, add more sub components when appropriate.

### Section 2.5. Hardware Parameter Optimization

In the terminology of machine learning, parameter optimization means searching for machine learning model's combination of parameters so that the predicted target values best match the real target values. This section is not about machine learning parameter optimization. In hardware, parameter optimization means that searching for values of specific settings of hardware, so that it maximizes the optimization goals. This section is about the innovation of using machine learning models to virtually find the optimal hardware parameters.

This is how the optimization models can be used to find the optimal hardware parameters. In the optimization models according to some embodiments of the present disclosure, the settings of hardware are not parameters of models, but input of models. They can be in x_m, such as the designed number of loops in coil, or sometimes in x_(1-t), such as the temperature of a specific part of the hardware that can be set and changed at different time.

Once an optimization models is provided, for each goal, in a simulated environment, one can virtually change the values of parameter setting related values of x_m and x_(l-t) in a simulated environment, with real, historical, simulated or predicted values of t, x_(l-t,t<n), y_(si-t,t<n), and y_(oj-t,t<n). Then it will give predicted value sequence of y_(oj-t,t>=n). It is then possible to see which combinations of parameter setting related x_m and x_(l-t) values gives the most desirable y_(oj-t,t>=n). Usually the application is to maximize the value of the mean of values of y_(oj-t,t>=n).

The strategy to vary x_m and x_(l-t) in their own space in the parameter optimization process is called parameter search strategy. In some embodiments of the present disclosure, the parameter search strategy is flexible, and it should be emphasized that parameter search strategies not commonly used in hardware/manufacturing industry but commonly used in machine learning practice can also be applied to hardware/equipment optimization under a framework of some embodiments of the present disclosure. There are three common machine learning parameter search techniques that can be applied to some embodiments of the present disclosure.

Firstly, it can be grid search, which is what traditionally equipment manufacturers do in their physical lab setting, usually before the equipment is released to real world production.

Various embodiments of the present disclosure provide the following innovative aspects. (1) It moves this physical lab testing process to virtual machine learning based simulation, in theory saving time and resources. Traditional hardware engineers tend to do the optimization in the physical lab. They actually change the design specifics or settings of equipment and measure the real optimization goal values. After they exhausted their search space (i.e., all possible combination of hardware parameter values they can afford to set and test), the combination of x_m and x_(l-t) that produce the best y_(oj-t,t>=n) is chosen. (2) Some embodiments of the present disclosure use time series models for predicted value of optimization goal. Traditional hardware engineers tend generalize their data with explicitly parameterized mathematical formula, not machine learning models. Then based on their generalized mathematical formula, they expand their search space. They usually physically test in a controlled lab environment with fixed conditions such as control intervals of temperatures, etc., and try to find optimal settings for an optimization goal, ignoring that running equipment in the industry are continuously facing changing conditions. That is why in the lab equipment have certain values for their optimization goal, but usually in industrial usage in real environment, they will have varied performance with regard to that optimization goal. Various embodiments of the present disclosure take into the account of changing y_(si-t) values when predicting optimization goal values y_(oj-t). Some of machine learning technique, such as deep learning, can achieve universal approximation of relationship between input and target values, which is hard to write explicit parameterized mathematical formula. Some embodiments of the present disclosure apply machine learning techniques, agnostic of specific choice of modeling technique, to the hardware equipment optimization process.

The second strategy is random search. The combination of search space when one has more than one parameter to search increases rapidly following the formula of combination. When it is desired to reduce the combination of parameter values in x_m and x_(l-t), which are used to get predicted or real optimization goal value, some embodiments of the present disclosure suggest (pseudo) random generation of combinations of parameter values. This random search strategy is common for machine learning optimization. Various embodiments of the present disclosure innovatively apply random search for hardware parameter optimization.

The third search strategy is sequential model-based optimization (SMBO) approach, which improves over random search. Sequential Model-Based Optimization (SMBO) is used for optimizing expensive-to-evaluate functions. It's particularly useful when each function evaluation takes a large amount of time or resources, such as tuning hyperparameters of a machine learning model. SMBO is very powerful when evaluations of the functions are very expensive, such as training a large machine learning model. It is widely used in hyperparameter optimization for machine learning models.

Instead of randomly picking the next combinations after the seeding combination, one picks the next combination inferred from machine learning models. This strategy is adopted in some embodiments of the present disclosure because if the optimization model is based on deep learning, even virtual evaluation is computationally expensive. SMBO based search strategy is commonly used in machine learning parameter optimization and again not in hardware parameter optimization.

Tree-structured Parzen Estimator (TPE), belonging to the family of Sequential Model-Based Optimization (SMBO) methods, is used in Optuna™ (Akiba, Sano et al. 2019) and a variation, Adaptive TPE, is used in HyperOpt (Bergstra, Yamins et al. 2013).

The Tree-structured Parzen Estimator (TPE) is an algorithm used for hyperparameter optimization in machine learning. TPE can be more effective than other hyperparameter optimization methods, such as grid search or random search in high-dimensional hyperparameter spaces. TPE can also effectively handles non-uniform and conditional distributions of hyperparameters.

In some embodiments of the present disclosure, Optuna™, which is an open-source hyperparameter optimization framework, can be adopted for machine learning. Optuna™ provides a user-friendly yet powerful way to automatically search for optimal hyperparameters for machine learning models, and can help improving efficiency in finding high-quality solutions within a short time frame.

The term “adaptive” in Adaptive TPE suggests that the algorithm dynamically adjusts its approach as it learns more about the hyperparameter space. As the optimization process progresses, the algorithm becomes better at predicting which hyperparameters are likely to yield better performance, focusing the search in the most promising regions of the hyperparameter space. In HyperOpt library, Adaptive TPE is used to efficiently and effectively find the best hyperparameters for a given machine learning task. It's particularly useful when dealing with high-dimensional spaces and complex objective functions, where traditional methods like grid search become computationally infeasible.

Users dealing with hardware often cannot use libraries HyperOpt or Optuna™ directly on the hardware parameter optimization problem because they are written specifically for optimizing supported machine learning models.

Various embodiments of the present disclosure can, however, apply the process principals of HyperOpt or Optuna™ to hardware parameter search strategy. TPE is a sequential model-based optimization (SMBO) approach. In machine learning hyperparameter tuning, TPE models P (x|y) and P (y) where x represents hyperparameters and y the associated loss, the objective function, and then chooses the x that minimizes the expected value of y. It separates the parameter space into two regions based on the observed values of loss, and then preferentially samples from regions where loss is lower. In some embodiments of the present disclosure, y can be replaced with an objective function y_(oj-t), and x should be replaced with parameter values in x_m and x_(l-t), and depending of the specific jth hardware optimization objective, some embodiments of the present disclosure can aim for maximize or minimize y_(oj-t). The preferentially samples from regions where y_(oj-t) is larger or smaller, depending on the specific optimization goal. Some embodiments of the present disclosure can also use the principles Adaptive TPE to adapt the number of samples balancing exploration and exploitation during optimization. Various embodiments of the present disclosure innovatively apply SMBO to hardware optimization.

Usually, in a traditional manufacturing process, once the optimal set of parameters are found in the laboratory setting, they will be set to the hardware, and will not change. A system design according to some embodiments of the present disclosure has the online service part in FIG. 1. In industrial production in real-time, the online machine learning model have the capacity to suggest new parameter values outside of their respective ranges that have been previously verified in the physical lab, because optimization models are updated online. The newly suggested set of hardware parameters may not be trusted yet to be set back to the hardware immediately. The ranges of parameter values can be set within which are allowed to be updated by online machine learning models in production in the machine learning service in 140 of FIG. 1.

One can also set rules on what ranges of parameter values are not allowed to be directly set back to the hardware, but test the newly suggested parameter values in parallel for physical lab to verify if the suggesting is true. Using this method, the EquiFormer overall system can reduce risk in production as well as accelerate the iterations of product development in the physical lab. Old manufacturing equipment development cycle lacks machine learning suggested parameter and real-time industrial data feedback, and the development flow is almost always from lab to industry, and hard to parallel the process between lab development and industrial use.

Using Chip Manufacturing Equipment (e.g., Photolithography Machine) as an example, the measured non-time stamped specifications may include power requirements (voltage, amperage), dimensions of the machine, wafer size compatibility (e.g., 300 mm wafers), light source type and intensity (for photolithography), resolution and overlay accuracy, throughput (wafers per hour). The time-stamped sensory data may include wafer temperature and humidity, vibration and stability measurements, light intensity and wavelength (for photolithography), real-time power consumption, chamber pressure (for vacuum processes), and positioning accuracy of wafer stage. The optimization goals may include yield (percentage of good chips per wafer), precision and repeatability of patterns, throughput (maximizing the number of wafers processed), minimizing defects and contamination, and energy and resource efficiency. The abnormal events include misalignment or patterning errors, equipment vibrations affecting resolution, contamination of wafers, light source malfunction (in photolithography), and vacuum system failures (in deposition or etching equipment).

### Section 2.6. Abnormal Event Models

In machine learning practice, industrial abnormal events such as failures, cyberattacks, natural disaster-induced abnormalities, etc., pose a unique modeling challenge and characteristic: such abnormal events are rare in historical data. In traditional supervised learning methodology, this is characterized by the rarity of labels for such abnormal events. In generative artificial intelligence methodology, this is characterized by the rarity of tokens representing such abnormal events in the corpora. An obstacle in the past is that equipment is isolated to each other, so the abnormal events do not get collected enough for machine learning model to train. In a system design according to some embodiments of the present disclosure, the innovation mainly is in the combined hardware and machine learning infrastructure and use this infrastructure to apply to abnormal event modeling. For manufacturing equipment, the equipment data collection service and machine learning service can be in the cloud, and a request can be made to IoT infrastructure to send sensed event data (including abnormal events such as failure) into cloud.

More abnormal event data can therefore be obtained to build models because of the cloud share. After the abnormal event models are built, the models can be shared on the cloud with other pieces of equipment. As such, even in scenarios where a specific piece of equipment has never failed (an example of an abnormal event) in a particular factory, but another similar piece of equipment has failed, and the abnormal event models are trained on the cloud, the abnormal event models can still be applied to the never-failed piece of equipment to predict its future failure. It is like how a machine learning model works in cybersecurity. Even if a new type of attack is not discovered in the US, but as long as it is discovered in somewhere else and the attack model is trained and shared in the cloud, this attack model can predict the attacks in the US. FIG. 4 illustrates the IoT integration into the machine learning system of EquiFormer.

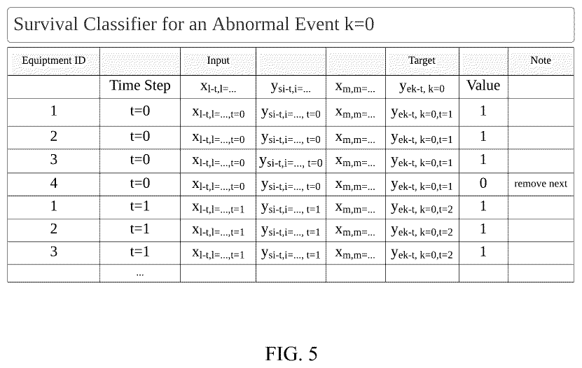

Here is a survival classifier machine learning approach for abnormal event models (not the transformer approach in Section 3). The term “rare” that describes abnormal events in machine learning is relative. The target is whether the abnormal event y_(ek-t, t=n) happened at time n, with a value of 1 vs. not happened, with a value of 0. In each time step of a given time period, if a given abnormal event does not happen for the most of the time, this given abnormal event is rare. If the number of abnormal events in the historical data is an order of magnitude lower than a hundred, new methods to model and predict abnormal events are described in Section 3. For abnormal events such as hardware failure that might happen less than often but still happen for an empirically estimated minimum of about more than a hundred times in the shared historical data, traditional machine learning technique can still be used, such as survival classifier models as shown in FIG. 5. For training, the input of the historical abnormal event models are sensory input y_(si-t, t=n−1) and time sensitive non-sensory input x_(l-t, t=n−1) at a previous time step n−1 and x_m which varies across equipment, but the survival classifiers need to organize the input and output data their own way. Each row in the data represents a piece of equipment at a specific time step (t from 0 to n), its input variables, and the status of the historical abnormal events as target. Once an equipment failed (not survived) at a time step n, it no longer presents in data at time step n+1. Because of this elimination of requirements, every abnormal event will have its own model, instead of a model with multiple abnormal event target labels, except new methods described in Section 3. In order to deal with the imbalanced target data, one just need to carefully sample and weigh data points where a historical abnormal event happened vs. not happened. Please also note that with the survival classifier machine learning approach, the training data actually take a sequence of previous time steps across rows, see the Time Step column in FIG. 5. In a specific row, the label in the Target column in FIG. 5 is the immediate next time step of the input time step. Every row at one time step can be important for this solution and will be discussed in more detail.

For prediction, if persons skilled in the art want to predict abnormal events many steps into the future time, actual sensory data used in the training will be replaced with predicted sensory values in the future time steps from the sensory model. Abnormal events happen rarely. The overall machine learning architecture in FIG. 2 with multiple stacked layers of machine learning models provides a unique advantage in some embodiments of the present disclosure for the utilization of abnormal event models.

This architecture in some embodiments of the present disclosure can predict abnormal events many time steps into the future. This ability to forecast abnormal events into many steps into the future (1) gives the service layer in FIG. 4 and human administrators sufficient time to react and (2) gives the action recommendation model ability to output predicted actions many steps into the future. On the other hand, if the abnormal event models can only take in input from actual data such as sensory data in previous time steps up until the immediate previous time step, and a devastating abnormal event is predicted to happen only one time step away, there will be not enough time for correction or action to be taken to alter the equipment statues to avoid such abnormal events. In a machine learning architecture that is missing the first layer of models especially the sensory model, or if the sensory model is not a sequence model including time series model, it is impossible to obtain sensory input data many time steps into the future. Then only having actual sensory input and trying to use survival classifier machine learning approach to predict abnormal events will inevitably run into problem of not able to forecast predicted abnormal events many steps into the future. In training, if an abnormal event label is at the immediate next time step, it is obvious that the prediction of abnormal events based on actual sensory data can only be the next time stamp. In training, if the historical abnormal event label is at many time steps later, an abnormal event model may not be able to capture the significant change in the input sensory data immediately prior to or in a short period of time steps prior to an abnormal event, thus may be incapable of predicting the abnormal event many time steps later.

A novelty aspect of applying the survival classifier model approach to the equipment abnormal event modeling can include that (1) it is applied to a sequence of equipment sensory data, and survival classifier is used to model the immediate next step's abnormal event. Equipment sensory data regularly are modeled with time series modeling approach. However, in other persons' designs, the abnormal event is part of the time series model, that is, treating y_(ek-t) as if it were y_(oj-t). In machine learning's perspective, the y_(oj-t) usually would have a value and varies within a reasonable range, that is, its observations form a random distribution. In this case, it is not a problem for time series modeling. However, this time series approach on abnormal events may inevitably run into the imbalanced target data problem without a good solution. With survival classifiers on top of time series, it is possible to eliminate and sample at row level, providing additional tools to deal with imbalanced target data. Other novel aspects may include: (2) usually, survival classifier modeling approach is applied to patient/disease survival data, not hardware equipment data. (3) Novel transformer model specific modeling technique for abnormal event models will be discussion in section 3.3, which can model even fewer incidences of an event.

### Section 2.7. Action Recommendation Models

After the prediction of abnormal events, hard coded logic or a different machine learning model can be implemented to provide the next action(s). Examples of such scenarios include but not limited to: if a predicted sensory value (temperature, amplification, etc.) exceeds certain threshold, or if an abnormal event is predicted to happen (e.g., a part of equipment will fail), and then evoke an action (e.g., change that part, add maintenance procedures, add lubricant oil, etc.). Traditional hard coded logic, which are not in the claim of this patent, can only encode relatively simple if then relationships. This patent will skip details of possible traditional hard coded logic but focus on machine learning solutions.

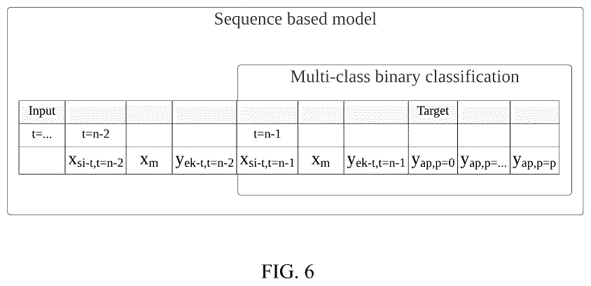

FIG. 6 illustrates the organization of input and target data for action recommendation models. Those skilled in the art, based on the present disclosure, can innovatively apply recommendation system's machine learning modeling technique in a novel way to output predicted actions in manufacturing equipment. There are p available actions y_ap that previously actually took place in the factory. They are the target variables. They only take the value of 0 or 1. All the input of sensory model and all historical abnormal events happened are the input to the action recommendation models. The choice of the actual machine learning modeling technique is flexible. In this application scenario, the p available actions can be modeled by any multi-class binary classification models, such as tree-based models and logistic regression models, many multi-layer perceptron based deep learning models pervasive in the online ads industry (such as DIN, Wide&Deep, FNN, DeepFM, AFM, NFM, FM, etc.) (Wang 2020), or sequence based deep learning models such as LSTM (Pan, Sheng et al. 2019), etc. After a numerical value for a specific action is assigned by a multi-class binary classification model, the strategy to actually accomplish the predicted action is flexible. For example, for actions to prevent critical failures, the preventative strategy can be over-engineered. For actions of routine maintenance, the strategy can be optimized with cost effectiveness and resources constraint.

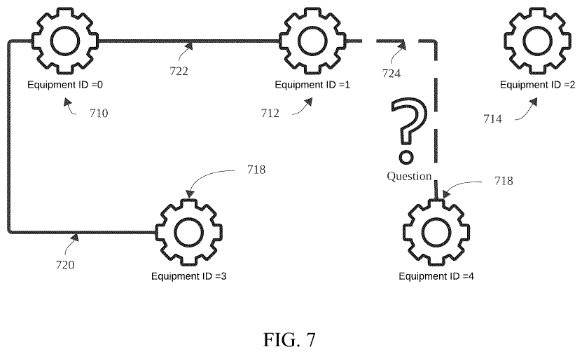

Alternatively, persons skilled in the art can also view this problem as a graph modeling problem, and use deep learning on graph (Zhang, Cui et al. 2020). The pieces of equipment are nodes. Actions of the same type (e.g., oil change maintenance) actually performed by the same entities (e.g., one maintenance expert) on different pieces of equipment form edges. The input to the multi-class binary classification models described in the previous paragraph, in addition to those described in FIG. 6, can alternatively be embeddings of the nodes from a graph modeling's point of view. In the present disclosure, an embedding refers to one vector from the output of the process of creating vectors using deep learning. Persons skilled in the art can compress the time dimension in the graph, i.e., only build a small number of graphs compared to a big number of time steps in the data and each graph does not change with time in relation to the next graph. Or alternatively, persons skilled in the art can build a graph that changes with time, i.e., a time-dependent graph. Although each snap shot of the graph could contain aggregated information from multiple time steps, there is an assumed relationship among snap shots of the graph on the time axis. Instead of predicting node classification, in this application scenario link formation (DGL_Team 2018) can be predicted, as shown in FIG. 7. There are pieces of equipment 710, 712, . . . , 718. In a time dimension compressed graph or a snap shot of a time dependent graph, it is known that equipment 710 and 718 formed a link 720 because they had the same action previously done. So does link 722 between equipment 710 and 712. There is no link linking to equipment 714. Now if a new equipment 718 is predicted to form a link to any of the existing linked equipment 710, 712, 714, then equipment 718 is predicted to have the same action that formed the link.

A novel aspect of some embodiments of the present disclosure can be that this graph link formation prediction approach has not been applied to the maintenance and failure prevention problem for hardware equipment. Usually, graph is used for drug discovery, social network, web page link, etc.

After so many supervised modeling techniques that output predicted actions, one can even add an ensemble layer to see which action get the majority vote from so many models. More variations and implementations can be provided after the introduction of transformer in the section on EquiFormer, and applying transformer specific modeling technique to provide actions in section 3.4.

### Section 2.8 Hardware Control System

A hardware control system is depicted in FIG. 1. It is a pivotal component responsible for (1) executing optimization strategies by maintaining the hardware at optimal operating parameters, whether in real-time or through scheduled adjustments, and (2) executing the predicted abnormal event intervention actions by preemptively altering equipment operations to prevent or lessen the impact of such events. Both execution strategies (series of actions or operations) are formulated by the machine learning architecture and service. By altering the equipment operating parameters, the control system effectively changes the state of equipment operation to align with the predicted optimization goals and mitigate potential abnormal events.

In a broad sense, the entire EquiFormer system in FIG. 1 is a hardware control system using machine learning to control hardware equipment 164. In a narrower sense, the hardware control system comprises the hardware administrator 154, the application service 150, the optional communication component 168, the controllers 166, and the IoT sensors 162 which provide data feedback. As used herein, the term hardware control system is defined in the narrower sense.

The application service 150 comprises two primary components: (1) an optimization component that receives input signals from the hardware optimization model, and (2) an abnormal event intervention component that takes input signals from the abnormal event model and the action recommendation model. For example, the predicted abnormal events could be mechanical failures, overheating, or unexpected collisions. The recommended action could be, for example, changing mechanical parts to avoid mechanical failure, reducing motor speed to prevent overheating, or adjusting trajectories to avoid collisions, and recalibrating sensors to address environmental change.

(1) Comparison of Signals: It compares the input signals from the machine learning models with the current state of the hardware. This involves assessing discrepancies between the machine learning predicted optimal parameters or intervention parameters, and the actual operational parameters of the equipment 164.

(2) Generation of Software Control Signals for Equipment: Based on the comparison, the application service 150 generates executable software signals capable of modifying the equipment operating parameters. These software signals instruct the controllers how to alter the state of the hardware operation, enabling downstream adjustments to be made in response to predictive insights. The software-generated control signals can be, for example, in the form of key-value pairs in json, and yaml formats. An example could be {“action”: “increase”, “object_id”: “motor xyz”, “parameter_id”: “motor_speed_abc”, “parameter_unit”: “RPM”, “amount”: 10}.

(3) Generation of Computer Hardware Control Signals: To communicate the software-generated control signals to hardware, the application service 150 translates these signals into computer hardware control signals and sends them out via computer ports. Although the entire data service 104, machine learning service 106, and application service 150 can reside in the cloud, the endpoint of the application service 150 that interacts with the hardware layer 160 needs to produce signals that the hardware layer can understand. For example, the software control signal {“action”: “increase”, “object_id”: “motor_xyz”, “parameter_id”: “motor_speed_abc”, “parameter_unit”: “RPM”, “amount”: 10} must be translated by the application service 150 into computer hardware control signals such as: Pin a in port x at time step 0: A high voltage (e.g., 5 volts) indicates an increase action. Pin b in port x at time step 0: A high voltage indicates that the object with ID “motor_xyz” should be operated on. Pin c in port x at time step 0: A high voltage indicates that the parameter ID “motor_speed_abc” should be adjusted. Pin d in port x at time step 0: A high voltage indicates that the parameter unit is RPM. Pin e in port x at time steps 1-100: At each time step, a high voltage (5 volts), equivalent to a binary “1” in a 0 vs 1 system, indicates a unit of increase. Thus, a signal sequence of “111111111100000 . . . 0” represents an amount of 10 units.

In the hardware layer 160, the optional communication component 168 performs the following function:

(4) Relay the Software Control Signal to the Controllers: If the controllers are not directly connected with the computer ports, an optional communication unit 168 is added in the hardware layer 160. In this section, we discuss using WiFi or LAN for communication. While Bluetooth can also be used to transmit control signals, it employs different protocols and mechanisms. For brevity, we will focus on WiFi and LAN, noting that Bluetooth implementation would require adaptations to the Bluetooth protocol stack. The communication component based on quantum communication will be discussed in section 4.

After the application service 150 serializes the software control signals into JSON, XML, or a binary protocol suitable for transmission over WiFi or LAN, the communication component 168 encapsulates the signal into network TCP or UDP packets with the necessary protocol headers (e.g., TCP/IP headers for LAN or WiFi communication). The communication component 168 uses IP addressing to route the packets to the appropriate controller on the network. The packets are transmitted over WiFi or LAN using standard wireless or wired signaling protocols.

In the hardware layer 160, the controller component 166 performs the following functions:

(5) Generation of Physical Equipment Control Signals: Upon receiving the control signals from either the communication component 168, or the application service 150, the controllers 166 process the signals to extract the control instructions. For instance, the controllers 166 might first extract the signals: interpret the “action” field to determine that an increase operation is required; use the “object_id” to identify “motor_xyz” as the target device; identify the “parameter_id” corresponding to “motor_speed_abc”; apply the “parameter_unit” of RPM to ensure the correct unit of measurement; increment the motor speed by the “amount” value of 10 units.

The controllers then translate these instructions into physical equipment control signals that directly control the equipment. Remotely configurable and programmable optical programming processors are a type of controller described in Section 4. In this example, if the equipment is a three-phase AC motor with 4 poles, increasing the supply AC frequency will increase the motor speed. The controllers might be comprised of variable frequency drives to send a physical signal increasing the supply AC frequency by 0.333 Hz according to a synchronous speed formula. Which motor is controlled might depend on the wiring and configuration of the controllers.

IoT sensors 162 provide the following functions.

(7) Collection of Equipment Data for Feedback Loop: IoT sensors 162 within the hardware system 160 collect real-time data from the equipment 164 and feed it back to both the data collection and storage component 104 and directly to the human hardware administrator 154 and the application service 150. This real-time feedback enables iterative adjustments to control signals without the need for computationally intensive processes from the equipment data service 104 and the machine learning service 105. For example, if a motor does not reach the desired speed due to unforeseen constraints, the application service 150 can promptly send new control signals to adjust the operation accordingly.

The control system allows operations in the following dual mode.

(8) Autonomous and Human-In-The-Loop Operations: The control system is versatile in its operation, capable of executing actions/operations both with and without explicit input from a human hardware administrator 154. In scenarios where autonomy is preferred, the system can autonomously implement intervention actions to prevent equipment failures or optimize performance. Especially when the underlying machine learning service is capable of foreseeing predicted abnormal events and intervention actions far into the future, many of the interventions can be automatically scheduled and executed without human intervention. When the predicted failures or intervention actions require actions faster than a human can react, the control system can also act automatically on its own. Alternatively, alerts and recommendations can be displayed on the display screen 152 or communicated through other interfaces, allowing human operators to review and manually intervene if deemed necessary. This dual capability ensures that the system benefits from automated efficiency while still incorporating human judgment when appropriate. This dual model allows multiple routes to achieve the same operation. For example, if the recommended intervention action in 152 is to reduce a motor's speed to zero, there are three routes. First, the hardware administrator can directly shut down the switch to the motor. In this scenario human operation is of higher priority than the autonomous control system. This direct operation is like pressing the power-off button on a robotic cleaner. Second, the controller can send a signal to the motor to cut the voltages to zero in the supply of electricity. This operation is like on a robotic cleaner app, when the app decides the sweeping is done and the robotic cleaner is on the dock, the app stops the motor. Third, the application service can display the intervention action to the human administrator 154, and wait for a human response, then execute the human-intervened action. The human administrator can confirm to shut down the motor or alter the actions. This operation is like on a robotic cleaner app, when the app displays and asks the user for confirmation of shutting down the motor; the user can confirm the shutdown, or tell the app to run the robotic cleaner again without shutting down. However, in the current disclosure, although the hardware control system in the narrower sense shares some similarity with a robotic cleaner, the machine learning services and the EquiFormer system as a whole achieve far broader optimization goals and abnormal event interventions.

The hardware control system leverages the machine learning service 106 in FIG. 1 that utilizes a layered machine learning architecture consisting of sensory models, optimization models, hardware and control component, abnormal event models, and action recommendation models in FIG. 2. These models provide predictive insights into future equipment behavior, enabling the system to make informed adjustments. The sensory models offer predicted sensory values, the optimization models offer the optimal set of equipment operating parameters, the hardware and control component offers optimal strategies of actions, the abnormal event models predict potential abnormal events, and the action recommendation models suggest specific interventions. The application service 150 in FIG. 1 integrates these insights from the machine learning services 106 in FIG. 1, allowing the hardware control system to make nuanced decisions that optimize performance and enhance operational resilience.

Section 2.9. Comparison with Lookout for Equipment Service

A “lookout-for-equipment” function in some implementations is a service to warn equipment failure. A modeling part can be provided with online model refresh and service. On the machine learning model side, after future time sensory values are predicted, typically only statistical tests are employed to see if the predicted future sensor value is statistically significantly different from past time sensor values. If it is, alerts will be issued.

A machine learning service according to some embodiments of the present disclosure differs from other “lookout for equipment” functions in a number of ways.

For example, in some embodiments of the present disclosure, a very flexible machine learning technique can be selected for sensory model. The transformer architecture for sensory model in manufacturing data has not been envisioned before, and section 3 of the present disclosure further describes new applications and methodology of how to apply transformer-based technologies to manufacturing time series data.

In another example, the abnormal event alert in some embodiments of the present disclosure is determined by machine learning model in layer 2, not statistical test.

In yet another example, some embodiments of the present disclosure provide additional optimization models, and action recommendation models that are nonexistent in other implementations.

On the hardware side, a cloud service may lack specific IoT hardware design in the lookout equipment service.

In the following, it is further described what chips/components needs to be added to a specific hardware, optical programming processor, in order for the IoT machine learning service to work.

Specifically, to send abnormality alert, some other implementations use severity score and other scores, which is a statistical test-based approach (for example, when a new value comes in, a one sample test to determine if it belongs to a normal population is performed). Those implementations may declare that labeling abnormality can improve its alert accuracy, which does not mean that it uses the same machine learning modeling approach as that disclosed in some embodiments of the present disclosure. It might use other statistical tests as well (for example, when a new value comes in, a two-sample test to determine whether it belongs to a normal population or an abnormal population is performed).

Some embodiments of the present disclosure utilize machine learning modeling approach, and provides a novel large transformer model based solution in section 3 for this particular problem, and simultaneously, the normal behaviors of a group of hardware equipment with similar but different specifications, not of just one isolated equipment, are also considered in the solution provided here.

After an abnormality is detected, other types of services may not provide machine learning solution at all. User provide their own downstream action, either by manually adding action once an abnormality is detected in lambda function (such as sending SMS to a phone number) or users build their own machine learning model. The present disclosure provides a machine learning modeling solution for the actions that should be taken automatically after an abnormality is detected.

### Section 3. EquiFormer: A Specific Implementation of Transformers on Hardware Equipment

### Section 3.1. Transformer as an Embedding and Foundation Model

Transformer based model has been modeling sequences in text, image, and recently in time series (specifically finance, such as stock price, and retails), and may have never been applied to hardware equipment data and control. Because sensory models and optimization models in the present disclosure are time series, the present disclosure can apply such powerful transformer model to the hardware equipment modeling problem. The innovation is that transformer may have not been used in this hardware equipment included system according to some embodiments of the present disclosure, especially for manufacturing data. Many of the embedding method, fine tuning, application to abnormal event modeling will for the first time be modified to solve hardware equipment data and or manufacturing problems which were hard to be solved with traditional methods and even with methods described in section 2 of the present disclosure. Section 3 further describes the novel transformer implementation in some embodiments of the present disclosure.

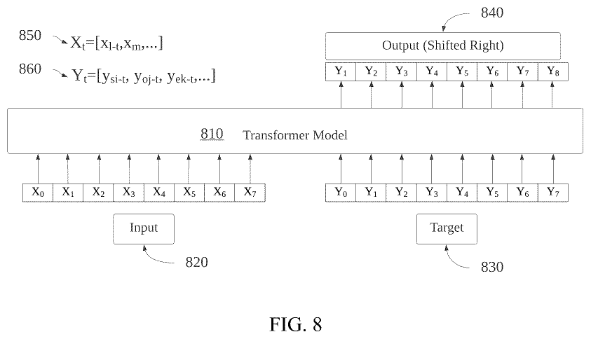

FIG. 8 illustrates the modeling architecture of the transformer-based foundation model for manufacturing hardware modeling. (1) In FIG. 8, it shows window size of 8, for illustration purposes, for time steps in both input 820 and output 830. The window size is flexible in the present disclosure. Please note that in transformer, the position step is slightly different from time step, but for simplification purpose, the existing subscript t can be used to represent position step. As in transformer, the position step is the step in the window size, and as window moves on time series data, the position step is still 0 to 7 in the case of a window size of 8, but the actual time step that is in X_t changes accordingly as window moves. That is, if a time series time steps are from 0 to 11, and the window size of transformer is 8: the first row of data in transformer's window consists of time steps from 0 to 7, the second row of data in transformer's window consist of time steps from 1 to 8. (2) The architecture inside the transformer is also flexible, for example, the number of layers, the position of the layerNorm, etc. (3) The Input data, X_t 850, is a vector/embedding of relevant and important input variables at its position (in this case a time step in the time series). The exact order, choice and embedding of input variables that assemble X_t is flexible. (4) The target data, Y_t 860, is a vector/embedding of relevant and important target variables at its position. The exact order, choice and embedding of target variables that assemble Y_t is flexible. In FIG. 8 for the illustration purpose, sensory information, y_(si-t), is regarded as part of target. However, given the flexibility of the transformer model's target vector, if the sensory model is not part of the use case, y_(si-t), can be part of the input vector, and target vector can remove its y_(si-t) component. (5) Output, 840, is the predicted target shifted one step to the right.

This architecture will call the transformer model an embedding model because as a deep learning model, the output of last layer, before the output of the target, is a vector, which serves as an embedding for that window beginning at a specific position. This architecture will also call the transformer model a foundational model because: (1) the transformer is capable, as many deep learning models, of modelling multiple labels in the target. The foundation model fuses models that have a time series component in FIG. 1, which includes the sensory models, the optimization models, the abnormal event models, and possibly the action recommendation models, into a unified modeling structure. In the case that the transformer model is used for the purpose of predicting sensory data and optimization goal targets, regardless of whether the target in training also includes abnormal event or action recommendation targets, it can be referred back to Section 2.6 for downstream abnormal event modeling and action recommendation with non-transformer-based methods. (2) it enables downstream application scenario of abnormal event prediction and action evocation with transformer-based methods. It is the foundation of all the downstream application scenarios.

The embedding of input and target are unique in some embodiments of the present disclosure. (1) In transformer models used in the large language models (LLMs), the input and target are both embedding for words. In some embodiments of the present disclosure, Y first can be a different category of variable from X. For example, when X is comprised of a vector of sensory data, Y can be comprised of a vector of optimization goals. (2) Y can take many forms and embedding. This flexibility in Y in some embodiments of the present disclosure, as opposed to the application scenarios in LLMs, gives a unique benefit of allowing the application of multi modal methods into EquiFormer's application scenarios. Transformer has a unique new research direction on fusion of multi modal, in which the current researches focus on the targets comprised of a mixture of text and images/videos (Gal, Alaluf et al. 2022). EquiFormer's targets are unique to existing multi modal researches: they are sensory data, optimization goals, abnormal events and actions. (3) Furthermore, if some of the sensory data can be transformed into images, EquiFormer has the flexibility of taking different forms of data as input/target of the transformer model. On one hand, Equiformer can use sensory data in its parameter form. One the other hand, EquiFormer can take a snap shot of the image, embed the image into convolutional neural networks (CNN), and then use the embedding from CNN either as input or target of sensory data. Such examples of data can be sound wave, light wave, particle imaging, quantum state tomography, etc. In the example of light wave, the parameter form can be amplitude, frequency, etc., of each component waves, and the CNN embedding form can be a vector of the light wave's image's CNN embedding.

Compared with some multi-modal researches, some embodiments of the present disclosure innovatively can add a CNN component to transform non-image input/target to image input/target from manufacturing equipment data.

### Section 3.2. Optimization and its Control

In some embodiments of the present disclosure, an application scenario of EquiFormer is hardware optimization and control, optimization can refer to an optimal input for manufacturing optimization goal, and control can refer to adjusting the randomness in the input to the optimal input calculated from the optimization model.

There are several solutions to solve the optimization problem with the transformer model.

(1) One can use method described in section 2.4: replacing other models with the transformer model described in section 2.4, varying hardware input to generate predicted optimization goal target values at future steps, and using predicted input values as input for optimization target when input values are not available at future steps. When the search space is large, one can see that this method is tedious.

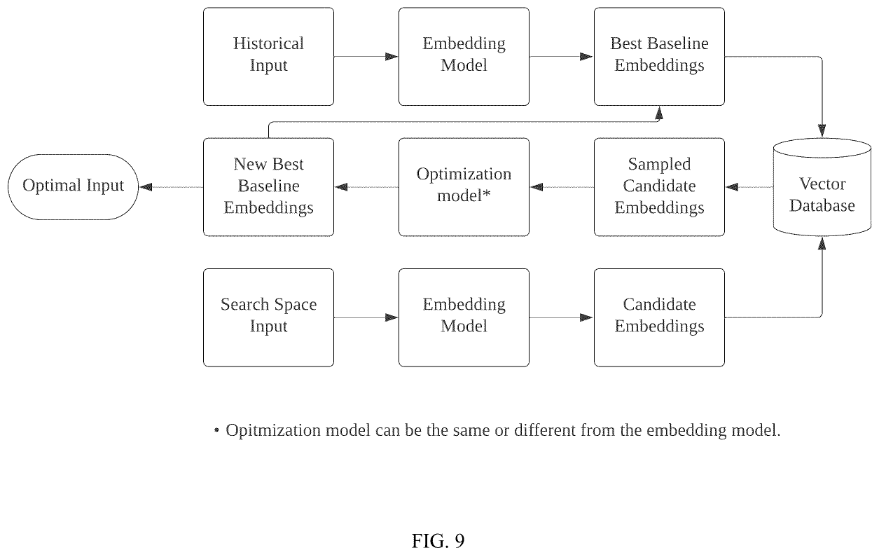

(2) Another innovation specific to transformer model is to leverage the transformer embedding. FIG. 9 shows a simplified flow chart to explain this process, which can be named as an EquiFormer based retrieval optimization in some embodiments of the present disclosure. Note that the embedding model can be the same or different from the optimization transformer model. However, both models need to be transformer models. When the embedding transformer model is different from the optimization transformer model, the target in the embedding transformer model can be different from the target in the optimization transformation model. In the present disclosure, it is assumed that the current optimization goal in the target for the optimization transformation model is the same as that when the optimization transformer is trained.

(2.1) In a given search space 910, those skilled in the art can use any methods (grid search, random search, or SMBO) in section 2.5 or beyond to generate input combinations. Then instead of actually generating target values from the transformer model, persons skilled in the art can generate embedding vectors from the embedding transformer model 920. Hereafter, those embedding vectors can be referred to as ‘candidate embeddings’ 930. The reason to generate embedding instead of target is that maybe persons skilled in the art need the embedding vs. target to reside in different systems (e.g., online equipment vs offline vector database 901), or maybe persons skilled in the art need to use the embedding from transformers trained in one set of target values to fine tune into a different set of target values, such as changed optimization goal. Plus, one less step in the transformer calculation (from embedding to target) may save a little bit of computation power.

(2.2) In the existing historical input 990, the input variable vectors can be feed into the embedding transformer model 980, to get embedding vectors. Hereafter, those embedding vectors can be referred to as ‘baseline embeddings.’ Note that the embedding transformer model, 980 and 920, is the same embedding transformer model. Note again that the optimization transformer model, 950, can be the same or different from the embedding transformer model. The only one “best” baseline embedding 970, is defined as the one vector from the baseline embeddings that generates the best optimization goal value.

(3.3) The distances of candidate embeddings 930 is compared with the best baseline embedding 970 in a vector database 901. A sample of candidate embeddings 940 can be obtained, which have small, medium, or large distance (or whatever sampling strategy one would like use to sample by distance) from the best baseline embedding. This step will dramatically reduce the number of candidate embeddings that need to be fed into the optimization transformer model 950 to evaluate target values. Note that a component of the target value is an optimization goal. In theory the candidate embeddings with the least distance to the best baseline embedding should generate similar target values, and those ones which are far from the best baseline embeddings should generate target values that are different from the base baseline target. The by-distance-sampled candidate embeddings that generates the new best target value become the new best baseline embedding 960.

(3.4) Step (3.3) is repeated and candidate embeddings that have small distance to previous candidate embeddings or baseline embeddings that are already evaluated are removed, to see if a new best candidate embedding can be found to replace the best baseline embedding, until exhaust the search space or reach the iteration limits. The corresponding input to the best candidate embedding is the optimal input to the hardware found.

(3.5) If there are multiple best baseline embeddings, one can either just loop through each of the best baseline embeddings, or use any parallel computing method to parallel the search process.

On the control side, after a set of optimal values for the hardware input is found, for each of the input, there are always randomness in the input value and will always not be exactly what the optimal value is. Then a control value is needed to adjust the randomness of the input value so that the input value will close to the optimal value as possible. In traditional control theory's explicit formulas, the parameter optimization to find the best control value is hard, and the final control value is usually a linear combination of components of control values. In some embodiments of the present disclosure, if the transformer-based foundation model (note that transformer model is not only embedding model, but foundation model for all time series models including sensory model, optimization model, etc.) or other time series models are used, and the target or output contains a component of sensory input data y_(si-t), then the problem can be solved in a novel numerical approach. For any randomness (change Δ in input values) added to the previous steps in y_(si-t, t<n), the future y_(si-t, t>=n) will be known from transformer model exactly. Transformer model, as a special case of deep learning model, has a property called universal approximation, meaning that it can approximate any explicit mathematical formulas. So that it is not necessary to rely on linear combinations to approximate control values.

Various embodiments of the present disclosure solve a difficult problem faced by traditional control theories, where explicit formulas are employed, that is, users need to know what exact parameters values the explicit formulas should take to approximate future values of input.

According to some embodiments of the present disclosure, it is no longer necessary to know those parameter values to accurately know the future values of input.

After the future y_(si-t, t>=n) are known for each time step, and are compared with the best input value y_si* for that y_(si-t), the control values can be easily computed using any control theory's methods. For example, persons skilled in the art can approximate differentials used in control theory with slopes from the machine learning model's predicted value over time steps, and integrals used in control theory with areas of the machine learning model's predicted value over time steps, and may not need to know what exact the parameter values are in the explicit formulas or what explicit formulas should be. Also, this method can simulate many y_(si-t), and their interactions are totally taken care of by the foundation model.

The present disclosure not only introduces machine learning models that can be used for time series data, but also provides a system of machine learning architecture for problems (not only the normal sensory data forecasting) in hardware equipment data and how data and machine learning models should be stacking on top of each other for the system to solve hardware equipment problems. Three layers of models are provided, wherein three problems are solved in layer 1. On the hardware optimization problem in layer 1, a novel control solution based on machine learning is also provided. Please also note that this novel control solution is not limited to transformer-based optimization models, but any machine-learning-based optimization models.

### Section 3.3. Transformer Specific Abnormal Event Prediction

Traditional supervised machine learning's abnormal event prediction in section 2.6 requires at least some abnormal events that actually happened in the past as label. Accordingly, section 2.6 focuses on the hardware innovation of IoT to collect and share abnormal event data for model building. An equipment lookout service in some other implementations described in section 2.8 is not predicting abnormal events per se. It is using statistic test to detect deviance of the sensory data from statistical metrics when the equipment is running normally. The method proposed here is very different from what is known to be zero, one and few shot learning in LLMs. In LLMs, because both the input and output are words, the entire foundation model learns and organizes relationship of words, and the learning are based on language-based input and output. In the present disclosure, the input can be different from the target, and the foundation model may have not been subject to human instructions or reinforcement learning from human feedback.

(i) When no historical abnormal event (e.g., failure, valued at 0) ever happened: the component of foundation transformer 810's output Y 860, that specific abnormal event's value, y_(ek-t), will always be 1 (running normal). However, other components of output Y 860 in the foundation transformer model still varies. The foundation transformer model 810 captures what a normally running hardware system's other target values should change according to input values. When varying input vector predicts y_(ek-t) that is far less (for example near 0) than actual value of y_(ek-t) which is 1 exceeding a threshold, or statistically significantly away from a sample of normally running hardware's predicted y_(ek-t) values, it is an indication of abnormality about the abnormal event. Probably the never happened abnormal event will happen at that step. This zero-negative-label learning fundamentally breaks through the supervised learning's curse that something has to happen before to be used as label. In the transformer-based foundation model, the crystallized relationship on a normal running hardware will give at least some indication of a never happened failure, thanks to the flexibility of target in the transformer model. In the present disclosure, there is no semantic component in the foundation model either in the input or output, unlike those in LLM. The inventor of the present disclosure has recognized that the transformer predicted y_(ek-t) values also form distributions, and the normal running hardware's predicted y_(ek-t) values form one distribution, and the abnormally running hardware's predicted y_(ek-t) values does not come from the normal running one's distribution. The predicted values of y_(ek_t) from normal vs non-normal running hardware form two distinct distributions. A statistical test of examining whether a predicted value of y_(ek_t) comes from a normal running hardware's distribution is a theoretical basis for some embodiments of the present disclosure to predict an abnormal event when it has not happened before. Once the predicted y_(ek-t) values came out of the foundation transformer model, the exact methods to determine there will be an abnormal event to happen can be flexible, and not limited to the threshold or statistical test mentioned here.

In contrast, in other implementations, “equipment lookout” does not have a model to predict y_(ek-t), does not use a transformer model to predict y_(ek-t), nor does it have a solution as described in the present disclosure for no previous historical abnormal event ever happened.

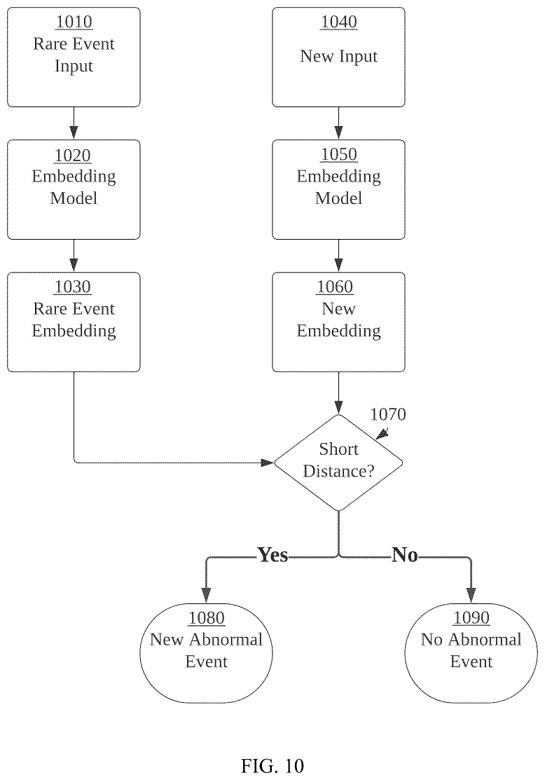

(ii) When there is at least one historical abnormal event: in this case, that special historical abnormal event has already been learnt and organized in the transformer-based foundation model. (ii.a) Firstly, even if only the method in (i) is used, it should give us better indication than (i) when there is no historical abnormal event ever happened. (ii.b) Secondly, since there is at least one historical abnormal event, the embedding approach can be used. FIG. 10 illustrates this embedding-based abnormal event prediction based on historical abnormal event only happened once. The input when the historical abnormal event 1010 happened, an embedding of that particular step's input embedding vector 1030 can be obtained through the transformer model 1020. When new other input value 1040 yields a new embedding 1060 through transformer model 1050 that is of very short distance from the historical abnormal event's embedding, that is an indication of another new abnormal event will happen. The decision mechanism 1070 to decide how short the distance is short can be flexible, for example, using threshold, statistical test or other methods.

(iii) When there are few historical abnormal events happened: this patent provides a method to do data level augmentation such as up-sampling of historical abnormal events, or transformer parameter tuning based approach for the model to better capture the relationship between input and abnormal events. Methods in the above two approaches are not limiting of the present disclosure.

### Section 3.4. Transformer Specific Action Evoking for Hardware

Various embodiments of the present disclosure provide novel applications of multi modal approach, and action evaluation approach to the action evoking problem for hardware.

The first approach leverages the multi modal capacity of the transformer model. Previously multi modal had been applied to images and texts. If specific actions being coded as 0 or 1 form a vector, the vector can be used as an input or target. Some embodiments of the present disclosure suggest that the action vector can be mixed with sensory and other data to form a multi modal transformer model. EquiFormer's innovation is that multi modal transformer can be applied to manufacturing hardware problems, and it suggests possible new target vector.

The second approach is the action evaluation. In previous LLM use cases, transformer can generate actions such as revoke a calculator/sql snippet (Fu, Ou et al. 2022). The action evaluation uses python or SQL snippets, or mathematical formulas, where the generated semantic sequence can be fed into a python interpreter or SQL engine to see if it runs or into a calculator to see if it calculates. Of course, it is necessary to have methods to decide when to generate those snippets or formulas in a natural conversation and decide what is the beginning and end of the generated texts that needs to be evaluated as an action. Those LLM problems are still very different from the hardware action evoking in this patent. Because there is no python interpreter or sql engine or calculator in some embodiments of the present disclosure, various embodiments of the present disclosure add task specific models to replace those evaluators in the LLM literature.

In a common practice of maintenance actions for hardware, the manufacturer usually will propose some scheduling (when a car has run x miles, it needs to change oil) or rules (when the x alarm light is flashing, the x component needs to be replaced). The scheduling is based on time steps, and the alarm light is based on sensory data. Thus, all of them are known in the transformer model. One can have simple rule-based evaluator just like the current industry does, or persons skilled in the art can make additional models based on the input of time steps and sensory data, with human labels of which action should be done (1) or not be done (0).

In some embodiments of the present disclosure, the transformer generated actions can be evaluated by human, and then be used in reinforcement learning.

### Section 4. EquiFormer for Optical Programming Processor

The predecessor of optical programming processor is called optical programmed processor (OPP), or in some even earlier patents called Adaptive Climate Controller (ACC) which is an earlier name for optical programmed processor.

The equivalency between ACC and optical programmed processor can be confirmed in some implementations. Optical programmed processor is described in a group of 17 references listed below. It uses light wave control, instead of electronic control, to output optimal electric motor parameters. OPP converts the modulating real time electromagnetic data (light) directly into electric signals (digital or analog) which can be directly amplified without added conversion to hi-power for direct use by the analogue motor which converts analog electric power to analog electric motion. Through the control, it increases the motor's energy efficiency, which is usually measured as a % ratio of the output mechanic power divided by the input electric power. In this predecessor, the parameters in the optical component, such as a frequency of each light source, to control the energy efficiency of electric motor is predetermined in the lab by physical experiment before manufacturing the optical programmed processor. Once determined, those parameters are hard written into the processor and will never be changed throughout the life time of the processor. In this old processor, the optimization goal is usually a static output variable such as torque that does not change with time but changes with the predetermined parameters. In some practical applications, it does change with time. That is why when the optimal programmed processor is added to the motor, a varying range of energy efficiency will be observed from real time data.

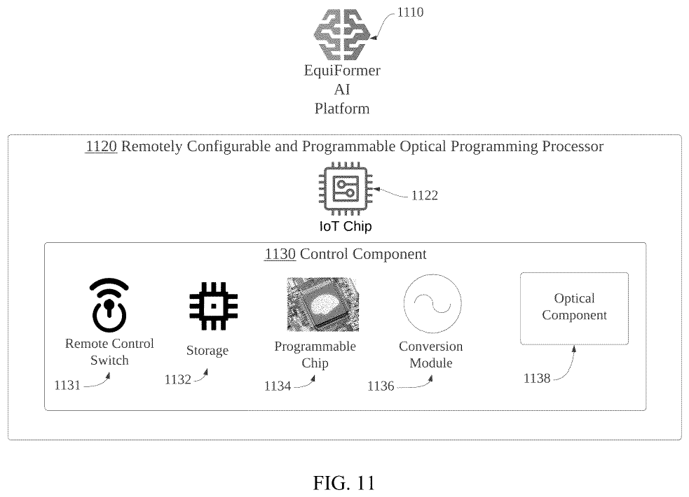

In some embodiments of the present disclosure, the remotely configurable and programmable optical programming processor (RCP_OPP) has the following innovations as shown in FIG. 11:

(1) It will use AI/machine learning system 1110 as described in either general systems in section 2 or specifically transformer-based system in section 3 to find the optimal hardware parameters which RCP_OPP will control, instead of using lab tests only. First generation optical programmed processor has no AI component at all. The specific machine learning model stacking on top of EquiFormer can be described as follows. First step, it can model optical and motor parameters as input, and torque as output, without time component, to accelerate initial parameter optimization. Then it may use EquiFormer for online optimization. The output from first model can be an input for EquiFormer. The control values are also derived from AI/machine learning system as described in Section 3.2. In fact, the optimization goals for the hardware which RCP_OPP controls are not limited to electric motor energy efficiency. It can be anything that can be controlled by light waves.

(2) RCP_OPP 1120 will add several hardware components to enable the hardware to talk to AI described in (1). Because now the parameters can be updated, some embodiments of the present disclosure can change the processor name from programmed (one time pre-written) to programming (continuously or intermittently online or offline update).

(2.1) a communication component such as IoT chips 1122 to real time transmit (both ways) the light-based controller's parameters to the data collection service/online optimization service; the exact implement of the communication component can be flexible and not limited to IoT chips.

(2.2) The rest of the hardware components are grouped as RCP_OPP control component 1130.

(2.2.1) a remote control switch 1131;

(2.2.2) a re-writable storage component to store hardware and RCP_OPP parameters 1132;

(2.2.3) a programmable chip to read and write the hardware and PCR_OPP's parameters 1134; and

(2.2.4) A conversion module 1136 converts each outputted hardware parameter in the form of a stored digital value to a light wave's parameter. For example, a continuous variable's digital values can be mapped to a light wave's parameter values through formulas, experiments, and other methods. This mapping can be programmable and re-writable, similar to the parameters in 2.2.2 and 2.2.3. From this mapping, persons skilled in the art understand that if a hardware parameter's value needs to be x, the corresponding light's parameter y needs to have a value of z. For instance, if a single-phase motor's torque needs to be 120 Nm, the light's frequency needs to be 80 Hz.

(2.3.5) RCP_OPP will include the optical component 1138, similar to its predecessor OPP. This component will control the interference of light waves to generate a new light wave, and one of the parameters of this new light wave represents the hardware parameter mentioned in (2.2.4). Afterward, this new light wave will be converted to other signals, such as, but not limited to, electrical signals using, for example, optical couplers and other devices. In most cases, each hardware parameter in (2.2.4) corresponds to one of the parameters of the new light wave. In some cases, one new light wave can have multiple parameters (such as light frequency and amplitude) that encode corresponding hardware parameters, and each parameter corresponds to one hardware parameter (such as input AC electrical frequency and voltage), respectively.

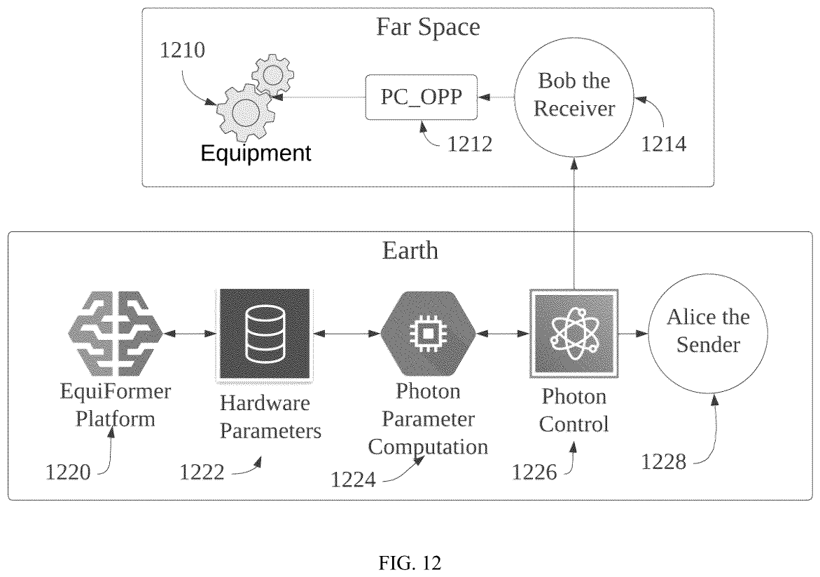

In (2.1), the use of IoT assumes using an internet signal from Earth or from satellites. When internet access is unavailable due to the extremely long distance required to receive an internet signal, such as in deep space, some embodiments of the present disclosure provide an innovative method to control the optical component on Earth. RCP_OPP has a unique advantage over electronic (digital or analog) control. RCP_OPP uses light waves, not analog or digital electronic signals, for control. Light exhibits wave-particle duality, a property that makes larger particles harder to observe. Based on this property, photons have demonstrated the ability to enter into quantum entanglements. Photons in quantum entanglement may be capable of communicating with each other over long distances. Based on these facts, some embodiments of this disclosure propose a new photon entanglement-based optical programming processor control system: a Photon-Controlled Optical Programming Processor (PC_OPP) to unilaterally control equipment from Earth to remote space as shown in FIG. 12. On Earth, the EquiFormer platform 1220 outputs the optimal hardware parameters 1222 (for optimization and control) for equipment in deep space. Another computation platform 1224 then inputs these hardware parameters and outputs the parameters of light waves or photons that will be used to control equipment far from Earth. A photon/light wave control system 1226 produces photons or light waves according to these parameters. Alice, the sender 1228, remains on Earth for monitoring or other purposes. Bob, the receiver 1214, is located in deep space along with its accompanying PC_OPP 1212. PC OPP uses Photon 2 to generate the light wave needed to control equipment 1210 in deep space. The exact implementation of this system can be flexible and extendable. However, it should be emphasized that even without internet access, unilateral control of equipment in deep space can be achieved using photon entanglement devices combined with PC_OPP in the system.

(3) This disclosure proposes three methods to achieve sending hardware parameters to deep space for PC_OPP. Although this disclosure primarily addresses equipment located on Earth communicating to equipment located in deep space, the arrangement may be reversed. In other words, situating the Earth-based equipment in deep space, and vice versa, would similarly enable communication from deep space to Earth. Accordingly, it is not necessary to limit the scope of the present disclosure solely to Earth-to-deep-space transmissions. At present, the described communication is unidirectional. However, by performing the same unidirectional communication operation twice—once from Earth to deep space and once from deep space to Earth—an effectively bidirectional communication link may be established.

(3.1) The first method uses a laser light. In (2), it is described how a certain hardware parameter value can correspond to a new light's parameter value. This new light can be generated by several light waves through interference. Optical component 1138 in FIG. 11 controls those several light waves' parameters, and the solution for this step was previously described in OPP-related patents. The next question is how to send a light (either one of the light sources that create the new interference light, or the new interference light) parameters into deep space if other communication methods are not available.

The steps are described in this paragraph. First, one hardware parameter value, which may or may not be from EquiFormer, maps to a laser light's light wave parameter value. Then, use a powerful light source with precision aiming capacity to transmit this laser light with the mapped light wave parameters from Earth directly into deep space. To avoid atmospheric effects on the quality of the light signal, persons skilled in the art can place the light source in a location with as little atmosphere as possible, such as at high altitude or on a device positioned above the atmosphere. Then a sensitive and capable receiver receives the laser light signals and collects photons in deep space. After that, the laser light's light wave parameter values are converted into other signals, such as electrical signals, to control the hardware in PC_OPP. The timing of the light wave signals could be one way to indicate which hardware parameter is being communicated, wherein the hardware parameter values are communicated sequentially. Dedicated different optical devices could be another way to indicate which hardware parameter is being communicated, allowing the hardware parameter values to be communicated in parallel.

The following two proposed methods communicate the hardware parameter values from the sender (on Earth) to the receiver (in deep space), one in an analog manner and the other in a discrete manner. The PC_OPP in deep space then converts the hardware parameter values into light wave parameter values to control equipment. This disclosure also emphasizes that if another controlling mechanism near the hardware equipment to be controlled is preferred, PC_OPP can be replaced with other mechanisms in the following two proposed methods. The following two proposed methods only serve as a communication mechanism.

(3.2) Use photon based on quantum teleportation of continuous variables. This method uses the continuous amplitude and phase quadratures of the light field as information carriers. As long as the values to be communicated are continuous, the method should be able to communicate them. Thus, both the hardware parameter values and the light wave's parameter values can be communicated. This disclosure remains flexible regarding which values are to be communicated. This method utilizes entangled states and classical communication to transfer an unknown quantum state from a sender to a receiver.

The steps are described as follows. First, the sender (Alice) and the receiver (Bob) pre-share a pair of continuous variable entangled states (e.g., a two-mode squeezed state). Then Alice prepares the light wave containing the specific phase and amplitude information to be transmitted. Then, for the joint measurement, Alice performs a Bell-type joint measurement on the light wave to be transmitted and her part of the entangled light field, obtaining continuous variable results (values of the two quadratures). Alice then sends the measurement results to Bob via a classical communication channel. Then, for state reconstruction, upon receiving the measurement results, Bob applies the corresponding phase shift and amplitude modulation to his part of the entangled light field, reconstructing a quantum state identical to Alice's original light wave. For light wave frequency values, persons skilled in the art can encode frequency information into continuous variables (such as phase or amplitude), transmit it via quantum teleportation, and then decode it at the receiver end. For which hardware parameter is communicated, persons skilled in the art can use different timing or use different photon communication devices.

(3.3) Use photon based on quantum bit encoding. To transmit a specific hardware parameter numerical value (e.g., 2.453) using quantum communication with photons, the numeric value needs to be encoded into quantum states to leverage the quantum properties of photons for transmission. To identify which hardware parameter is transmitted, the hardware parameter id also needs to be encoded into binary numbers if previous methods of using different timing or using different photon communication devices are not preferred.

(3.3) Use photon based on quantum bit encoding.

Steps are described as follows. First, binary encoding of the hardware parameter id and hardware parameter value is performed. (a) As long as the encoded value or values in binary form for a parameter id can be mapped back to the original parameter id only, it will work. The simplest solution for the hardware parameter id is to sequentially order all the hardware parameters and assign each one an ordinal id, then present this ordinal id in binary form. For example, if there are at most 16 hardware parameter values to be transmitted, hardware parameter id number 1 will be represented as “0001”. (b) The entire hardware parameter value also needs to be presented in binary form. For example, the value 2.453 will be converted to 10.0111001111 . . . . Its integer part, 2, will be converted to the binary form 10; the fractional part 0.453 will be converted to 0.0111001111 . . .

$$\begin{matrix}\text{"} \\ 0.453 \times 2 = 0.906 \to 0 \\ 0.906 \times 2 = 1.812 \to 1 \\ 0.812 \times 2 = 1.624 \to 1 \\ 0.624 \times 2 = 1.248 \to 1 \\ 0.248 \times 2 = 0.496 \to 0 \\ 0.496 \times 2 = 0.992 \to 0 \\ 0.992 \times 2 = 1.984 \to 1 \\ 0.984 \times 2 = 1.968 \to 1 \\ 0.968 \times 2 = 1.936 \to 1 \\ 0.936 \times 2 = 1.872 \to 1 \\ \text{"}\end{matrix}$$

If the precision is cut off, the value will be 10.0111001111. If the value is presented in floating point binary form, it will be 1.00111001111*2\hat{ }1. Thus, with the hardware parameter id and value combined, along with precision cutoff and floating point representation, the information to be transmitted is “0001 (the hardware parameter id) 100111001111 (significand of the hardware parameter value) 1000 (1, the exponent of base 2 in the IEEE 754 standard using 4 bits with a bias of 7) 1 (the positive sign)”. This is just an example. Persons skilled in the art can vary the exact encoding of the hardware parameter id and value information, but the essence is to encode all of them into a binary form.

Then, map the binary sequence onto quantum bits, with each bit corresponding to a quantum state. In quantum state representation, state |0 [symbol] represents binary 0 and state |1 [symbol] represents binary 1. Persons skilled in the art can utilize the photon's polarization direction, such as horizontal polarization (|0 [symbol] ) and vertical polarization (|1 [symbol] ). In some other implementations, persons skilled in the art can utilize the photon's phase difference, with 0 phase (|0 [symbol] ) and π phase (|1 [symbol] ).

Then, preparation and transmission of quantum states. Based on the binary sequence, the sender (Alice) prepares the corresponding sequence of photon quantum states and sends photons one by one to the receiver through optical fibers or free space.

Then, reception and measurement of quantum states: the receiver (Bob) receives the sequence of photons sent by Alice. Bob uses the correct basis (polarization basis or phase basis) to measure the photons and obtain the binary sequence.

Then, Bob reconstructs the original information: based on agreed-upon parameter id mapping and the precision of the numerical value, Bob reconstructs the information to be the 1st parameter id with a value of 2.453.

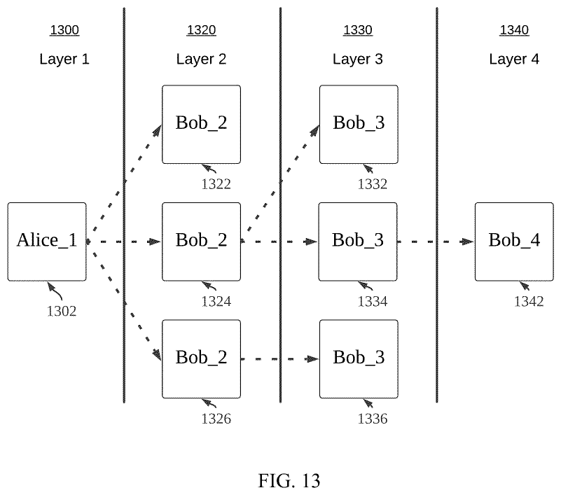

In practice, persons skilled in the art need to consider error correction and security, and often need additional classic communication methods to achieve this. However, the challenges of security and error in quantum bit communication often share many similarities with those that blockchain technology faces and attempts to solve. This disclosure proposes a blockchain-like mechanism to eliminate the necessity of using traditional communication methods in quantum bit communication, called the blockchained quantum bit communication network, which is depicted in FIG. 13. Alice 1302 is like the genesis block with height 0 1300. Alice 1302 sends the original quantum bit encoded information not just to one, but possibly to several first-degree chained Bobs 1312, 1314, and 1316 with height 1 1310. Each of those Bobs with height 1 then sends the quantum bit encoded information to between zero and several Bobs with height 2, and so on. When an end user, such as a piece of equipment, a computer, a human, or a control device, needs to access the transmitted information, error correction is performed by relying on the majority of the information from the Bobs, rather than verifying a subset of the single Alice-to-Bob information transmitted via classic communication methods. In some embodiments, all the Bobs could be in one place near where the end-use equipment is located, and verifying information on Bobs would be local. In other embodiments, Bobs could send their information to the end-use equipment remotely, with or without classic communication methods. At least from Alice to Bobs, the error correction of the information does not require classic communication methods anymore. Regarding security, at least tampering with a minority number of Bobs would not affect the correctness of the information. Persons skilled in the art could add a distributed quantum key in the information to be transmitted among Alice and Bobs, collectively functioning as blocks in a blockchain, to detect tampering of one of the blocks. Also, in order to compare the information received by each of the Bobs, Bobs need a re-writable storage unit to store the received photon information, as photons' quantum states themselves change once received and measured by Bobs. Just like a blockchain, the previous block's information and values are hashed and transmitted to the next block and stored in the next block in this block-chained quantum bit communication network.

Between Bob(s) and the end-use equipment, the PC_OPP is utilized for light-wave-based continuous precision control of the equipment. As the hardware parameter values transmitted in this quantum bit encoding are discrete in nature, a PC_OPP is not required. Persons skilled in the art can keep the PC_OPP and treat the re-constructed parameter value as if it were continuous. If persons skilled in the art determine that other methods of controlling equipment, such as electronic digital control widely used in control theory for discrete values, are more appropriate, they can swap the equipment control methods from PC_OPP to other methods. The block-chained quantum bit communication network is not limited to communication for hardware control. It is a generic mechanism for quantum bit communication.

### REFERENCES

U.S. D962,867 S, 2022 Sep. 6, Title: Inductor
U.S. Pat. No. 10,808,961 B2, 2020 Oct. 20, Title: Energy Saving Controller
US 2019/0257539 A1, 2019 Aug. 22, Title: Realtime, Verified and Automated Demand Response Energy Saving Controller
US 2019/0128548 A1, 2019 May 2, Title: Energy Saving Controller
U.S. Pat. No. 10,174,966 B2, 2019 Jan. 8, Title: Energy Saving Controller
U.S. Pat. No. 10,119,719 B2, 2018 Nov. 6, Title: Energy Saving Controller
U.S. Pat. No. 10,066,849 B2, 2018 Sep. 4, Title: Energy Saving Controller
U.S. Pat. No. 10,047,969 B2, 2018 Aug. 14, Title: Energy Saving Controller
US 2018/0038611 A1, 2018 Feb. 8, Title: Energy Saving Controller
US 2017/0051936 A1, 2017 Feb. 23, Title: Energy Saving Controller
U.S. Pat. No. 9,419,543 B2, 2016 Aug. 16, Title: Controlled Resonance in Electrical Power Devices
U.S. Pat. No. 9,410,713 B2, 2016 Aug. 9, Title: HVAC Fan Controller
US 2016/0223219 A1, 2016 Aug. 4, Title: Energy Saving Controller
US 2015/0159905 A1, 2015 Jun. 11, Title: Energy Saving Controller
US 2015/0060557 A1, 2015 Mar. 5, Title: Energy Saving Apparatus, System and Method
U.S. Pat. No. 6,498,546 B1, 2002 Dec. 24, Title: Utilization of Proximity Effect in Ripple Noise Filtering
U.S. Pat. No. 6,329,726 B1, 2001 Dec. 11, Title: Proportional Distribution of Power from a Plurality of Power Sources.
Liukis, A. (2020). “Approaching Time-Series with a Tree-based Model.” from https://towardsdatascience.com/approaching-time-series-with-a-tree-based-model-87c6d1fb6603.
Akiba, T., et al. (2019). Optuna: A next-generation hyperparameter optimization framework. Proceedings of the 25th ACM SIGKDD international conference on knowledge discovery & data mining.
Bergstra, J., et al. (2013). Making a science of model search: Hyperparameter optimization in hundreds of dimensions for vision architectures. International conference on machine learning, PMLR.
Wang, J. (2020). Deep Learning Recommender System, Publishign House of Electronics Industry.
Pan, J., et al. (2019). “Order matters at fanatics recommending sequentially ordered products by LSTM embedded with Word2Vec.” arXiv preprint arXiv: 1911.09818.
Zhang, Z., et al. (2020). “Deep learning on graphs: A survey.” IEEE Transactions on Knowledge and Data Engineering 34 (1): 249-270.
Gal, R., et al. (2022). “An image is worth one word: Personalizing text-to-image generation using textual inversion.” arXiv preprint arXiv: 2208.01618.
Fu, Y., et al. (2022). “MIGA: A Unified Multi-task Generation Framework for Conversational Text-to-SQL.” arXiv preprint arXiv: 2212.09278.
Patarasuk, P. and X. Yuan (2009). “Bandwidth optimal all-reduce algorithms for clusters of workstations.” Journal of Parallel and Distributed Computing 69 (2): 117-124.

All references cited in the present disclosure are incorporated by reference in their entirety.

For the convenience of description, the components of the apparatus may be divided into various modules or units according to functions which may be separately described. Certainly, when various embodiments of the present disclosure are carried out, the functions of these modules or units can be achieved utilizing one or more equivalent units of hardware or software as will be recognized by those having skill in the art.

The various device components, units, blocks, or portions may have modular configurations, or are composed of discrete components, but nonetheless can be referred to as “modules” in general. In other words, the “components,” “modules” or “units” referred to herein may or may not be in modular forms.

Persons skilled in the art should understand that the embodiments of the present disclosure can be provided for a method, system, or computer program product. Thus, various embodiments of the present disclosure can be in form of all-hardware embodiments, all-software embodiments, or a mix of hardware-software embodiments. Moreover, various embodiments of the present disclosure can be in form of a computer program product implemented on one or more computer-applicable memory media (including, but not limited to, disk memory, CD-ROM, optical disk, etc.) containing computer-applicable procedure codes therein.

Various embodiments of the present disclosure are described with reference to the flow diagrams and/or block diagrams of the method, apparatus (system), and computer program product of the embodiments of the present disclosure. It should be understood that computer program instructions realize each flow and/or block in the flow diagrams and/or block diagrams as well as a combination of the flows and/or blocks in the flow diagrams and/or block diagrams. These computer program instructions can be provided to a processor of a general-purpose computer, a special-purpose computer, an embedded memory, or other programmable data processing apparatuses to generate a machine, such that the instructions executed by the processor of the computer or other programmable data processing apparatuses generate a device for performing functions specified in one or more flows of the flow diagrams and/or one or more blocks of the block diagrams.

These computer program instructions can also be stored in a computer-readable memory, such as a non-transitory computer-readable storage medium. The instructions can guide the computer or other programmable data processing apparatuses to operate in a specified manner, such that the instructions stored in the computer-readable memory generate an article of manufacture including an instruction device. The instruction device performs functions specified in one or more flows of the flow diagrams and/or one or more blocks of the block diagrams.

These computer program instructions may also be loaded on the computer or other programmable data processing apparatuses to execute a series of operations and steps on the computer or other programmable data processing apparatuses, such that the instructions executed on the computer or other programmable data processing apparatuses provide steps for performing functions specified ill one or more flows of the flow diagrams and/or one or more blocks of the block diagrams.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more modules of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, drives, or other storage devices). Accordingly, the computer storage medium may be tangible.

The operations described in this disclosure can be implemented as operations performed by a data processing apparatus on data stored on one or more computer-readable storage devices or received from other sources.

Processors suitable for the execution of a computer program such as the instructions described above include, by way of example, both general and special purpose microprocessors, and any one or more processors of any kind of digital computer. Generally, a processor will receive instructions and data from a read-only memory, or a random-access memory, or both. Elements of a computer can include a processor configured to perform actions in accordance with instructions and one or more memory devices for storing instructions and data.

The processor or processing circuit can be implemented by one or a plurality of application specific integrated circuits (ASICs), digital signal processors (DSPs), digital signal processing devices (DSPDs), programmable logic devices (PLDs), field programmable gate arrays (FPGA), controllers, microcontrollers, microprocessors, general processors, or other electronic components, so as to perform the above image capturing method.

Implementations of the subject matter and the operations described in this disclosure can be implemented in digital electronic circuitry, or in computer software, firmware, or hardware, including the structures disclosed herein and their structural equivalents, or in combinations of one or more of them. Implementations of the subject matter described in this disclosure can be implemented as one or more computer programs, i.e., one or more portions of computer program instructions, encoded on one or more computer storage medium for execution by, or to control the operation of, data processing apparatus.

Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

In some implementations, the model can reside on local processing circuits and storage devices, and the training of the model can also be performed locally. In some implementations, the model and the training can be remotely or distributed, such as in a cloud.

Data, such as the inputs, the outputs, and model predictions, can be presented to users/operators on display screens, such as organic light-emitting diode (OLED) displays screens and liquid-crystal display (LCD) screens located on a manufacturing line and/or in a control room.

Although preferred embodiments of the present disclosure have been described, persons skilled in the art can alter and modify these embodiments once they know the fundamental inventive concept. Therefore, the attached claims should be construed to include the preferred embodiments and all the alternations and modifications that fall into the extent of the present disclosure.

The description is only used to help understanding some of the possible methods and concepts. Meanwhile, those of ordinary skill in the art can change the specific implementation manners and the application scope according to the concepts of the present disclosure. The contents of this specification therefore should not be construed as limiting the disclosure.

In the foregoing method embodiments, for the sake of simplified descriptions, the various steps are expressed as a series of action combinations. However, those of ordinary skill in the art will understand that the present disclosure is not limited by the particular sequence of steps as described herein.

According to some other embodiments of the present disclosure, some steps can be performed in other orders, or simultaneously, omitted, or added to other sequences, as appropriate.

Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

In addition, those of ordinary skill in the art will also understand that the embodiments described in the specification are just some of the embodiments, and the involved actions and portions are not all exclusively required, but will be recognized by those having skill in the art whether the functions of the various embodiments are required for a specific application thereof.

Various embodiments in this specification have been described in a progressive manner, where descriptions of some embodiments focus on the differences from other embodiments, and same or similar parts among the different embodiments are sometimes described together in only one embodiment.

It should also be noted that in the present disclosure, relational terms such as first and second, etc., are only used to distinguish one entity or operation from another entity or operation, and do not necessarily require or imply these entities having such an order or sequence. It does not necessarily require or imply that any such actual relationship or order exists between these entities or operations.

Moreover, the terms “include,” “including,” or any other variations thereof are intended to cover a non-exclusive inclusion such that a process, method, article, or apparatus that comprises a list of elements including not only those elements but also those that are not explicitly listed, or other elements that are inherent to such processes, methods, goods, or equipment.

In the case of no more limitation, the element defined by the sentence “includes a . . . ” does not exclude the existence of another identical element in the process, the method, the commodity, or the device including the element.

In the descriptions, with respect to device(s), terminal(s), etc., in some occurrences singular forms are used, and in some other occurrences plural forms are used in the descriptions of various embodiments. It should be noted, however, that the single or plural forms are not limiting but rather are for illustrative purposes. Unless it is expressly stated that a single device, or terminal, etc. is employed, or it is expressly stated that a plurality of devices, or terminals, etc. are employed, the device(s), terminal(s), etc. can be singular, or plural.

Based on various embodiments of the present disclosure, the disclosed apparatuses, devices, and methods can be implemented in other manners. For example, the abovementioned terminals devices are only of illustrative purposes, and other types of terminals and devices can employ the methods disclosed herein.

Dividing the terminal or device into different “portions,” “regions” “or “components” merely reflect various logical functions according to some embodiments, and actual implementations can have other divisions of “portions,” “regions,” or “components” realizing similar functions as described above, or without divisions. For example, multiple portions, regions, or components can be combined or can be integrated into another system. In addition, some features can be omitted, and some steps in the methods can be skipped.

Those of ordinary skill in the art will appreciate that the portions, or components, etc. in the devices provided by various embodiments described above can be configured in the one or more devices described above. They can also be located in one or multiple devices that is (are) different from the example embodiments described above or illustrated in the accompanying drawings. For example, the circuits, portions, or components, etc. in various embodiments described above can be integrated into one module or divided into several sub-modules.

The numbering of the various embodiments described above are only for the purpose of illustration, and do not represent preference of embodiments.

Although specific embodiments have been described above in detail, the description is merely for purposes of illustration. It should be appreciated, therefore, that many aspects described above are not intended as required or essential elements unless explicitly stated otherwise.

Various modifications of, and equivalent acts corresponding to, the disclosed aspects of the exemplary embodiments, in addition to those described above, can be made by a person of ordinary skill in the art, having the benefit of the present disclosure, without departing from the spirit and scope of the disclosure defined in the following claims, the scope of which is to be accorded the broadest interpretation to encompass such modifications and equivalent structures.

### Section 5. Transformer Related Innovations that are Useful to EquiFormer but not Limited to Hardware Equipment

### Section 5.1. Ring-all Reduce Gradient Update on Top of Model and Data Parallelism

For any deep learning model training, including any transformer model, with the special case of EquiFormer, persons skilled in the art have attempted various parallel techniques to increase training scalability. Such techniques include data parallelism, horizontal (tensor) or vertical (pipeline) model parallelism, and gradient averaging. This disclosure proposes a new method to utilize a particular gradient averaging technique, ring-all reduce, to work in conjunction with both data and model parallelism. When there is data parallelism and model parallelism, gradient averaging has been performed using a parameter server or other centralized solutions. That is, gradients from each node in the computation network need to be sent to one node or a centralized device for synchronization and averaging. When ring-all reduce, a peer-to-peer solution, is used for gradient averaging, only data parallelism but not model parallelism has been employed.

### Section 5.1.1. Ring-all Reduce Gradient Update on Top of Model and Data Parallelism for the Original Model

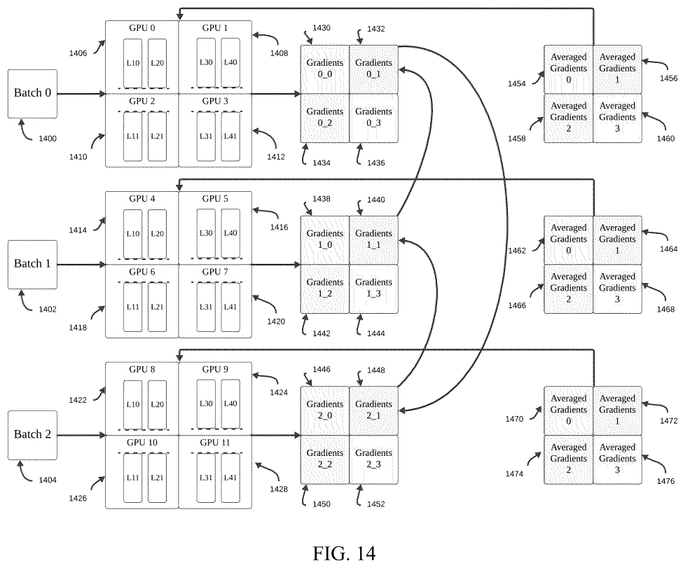

Ring-all reduce gradient update on top of model and data parallelism is depicted in FIG. 14. From left to right, data is first partitioned into batch 0 1400, batch 1 1302, batch 2 1404, and so on. An example model has four layers; the degree of horizontal model parallelism is 2; the degree of vertical model parallelism is also 2. In the example model, hidden layers are ordered from 1 to 4 from input (left) to output (right), and the pipeline parallelism divides layer 1 and layer 2 into one group, and layer 3 and layer 4 into another group. Tensor parallelism divides each layer into an upper part, denoted with 0 after the layer ordinal number. So L10 in GPU0 1406 means the first hidden layer's upper part. The model is divided into 4 quadrants: L10 and L20, L40 and L40, L11 and L21, and L31 and L41. Thus, the first copy of each quadrant of the model is in GPU 0 1406, GPU 1 1408, GPU 2 1410, GPU 3 1412. The second copy of the model is in GPU 4 to 7 (1414 to 1420). The third copy of the model is in GPU 8 to 11 (1422 to 1428). Note that this is only an example of the model structure plus horizontal and vertical model parallelism. The exact model structure and parallelism configuration are flexible and do not affect the proposed solution. If there are more or different types of model parallelism, the ring-all reduce for gradient averaging will still be applied to the corresponding GPUs that hold the same chunk of the model but different local gradients due to different data batches.

When batch 0 1400 data is input to GPUs 0 to 3 (1406 to 1412), each GPU obtains gradients for its respective quadrant of the model. That is, GPU 0 1406 will have gradients 0_0 1430, GPU 1 will have gradients 0_1 1432, GPU 2 will have gradients 0_2 1434, and GPU 3 will have gradients 0_3 1436. Similarly, batch 1 1402 and batch 2 1404 of data will also produce their respective gradients (1438 to 1452). Thus, gradients 0_1 1432, gradients 1_1 1440, and gradients 2_1 1448 are for the same quadrant of the model (L30 and L40) but come from 3 batches of data (batches 0 to 2, 1440 to 1404). Similarly, gradients 0_0 1430, gradients 1_0 1438, and gradients 2_0 1446 are for another quadrant of the model (L10 and L20), and so forth for each remaining quadrant of the model.

Now instead of centrally computing the average gradients for the same quadrant, this disclosure proposes using ring-all reduce (Patarasuk and Yuan 2009) to perform peer-to-peer averaging. For example, from gradients 0_1 1432 on GPU 1 1408 to gradients 2_1 1448 on GPU 9 1424, from gradients 2_1 1448 on GPU 9 1424 to gradients 1_1 1440 on GPU 5 1416, and from gradients 1_1 1440 on GPU 5 1416 back to gradients 0_1 1432 on GPU 1 1408, a ring-all reduce technique is applied to exchange and average their corresponding gradients. The directions of data exchange are indicated by arrows. FIG. 14 omits the arrows indicating the other 3 quadrants' ring-all reduce directions for better readability. The averaged gradients 1 for quadrant L30 and L40 will remain on their original 3 GPUs. That is, the same averaged gradients 1 will have 3 copies: averaged gradients 1 1456 on GPU 1 1408, averaged gradients 1 1464 on GPU 5 1416, and averaged gradients 1 1476 on GPU 9 1424. Each quadrant of averaged gradients will be used to calculate their corresponding weight changes and be added back to the quadrant of the model on their corresponding GPUs. For example, the averaged gradients of quadrant 1 copy on GPU1 1456 will be added back to the corresponding model quadrant L30 and L40 on GPU1 1408, and 1464 to 1416, and 1472 to 1424.

### Section 5.1.2. Ring-all Reduce Gradient Update on Top of Model and Data Parallelism for Low-Rank Adaption

Persons skilled in the art can partition matrices A and B in low-rank adaption (LoRA) across different GPUs that correspond to the original model's model parallelism partition and use ring-all reduce to update matrices A and B in a data and model

$$? \begin{matrix}W\_pt \_ [ 0 , 0 ] & W\_pt \_ [ 0 , 1 ] \\ W\_pt \_ [ 1 , 0 ] & W\_pt \_ [ 1 , 1 ]\end{matrix} ?$$

parallelism manner as well. Here, a method is introduced to achieve this goal. Mathematical representations of matrices are inevitably used for illustration purposes, but this disclosure focuses on the engineering aspects of how to allocate partitioned matrices on devices in the network for ring-all reduce, rather than on any mathematical proof.

There are two low-rank matrices A and B in LoRA. From the original LoRA method, the updated model weight matrix is W_fine_tuned=W_pre_trained+delta W=W_pre_trained+A B, in which delta W is the weight update, and a scaling factor is omitted. Let A={a_i,j} be an m×n matrix, B={b_i,j} be an n×p matrix, and delta W={w_i,j} be an m×p matrix. In this disclosure, a comma is placed between the row and column indices of an element for clarity. In usual nomenclature of linear algebra, no comma is placed between the indices. In this disclosure, a_i,j is equivalent to a_ij in the usual nomenclature. In normal LoRA nomenclature, n (the number of columns of A or the number of rows of B) is the rank. The rank n is usually much smaller than m or p, which is why it is called low rank. In this disclosure, n is used instead of r to illustrate the partition of a dot product of two matrices. Steps are as follows:

First, partition W_pre_trained into devices. Freeze all weights in W_pre_trained. Persons skilled in the art can be flexible with the number of horizontal vs. vertical partitions. For illustration purposes, W_pre_trained is partitioned into four quadrants as in FIG. 14 as follows:

$$W\_pre \_trained = ( \begin{matrix}W\_pt \_ [ 0 , 0 ] & W\_pt \_ [ 0 , 1 ] \\ W\_pt \_ [ 1 , 0 ] & W\_pt \_ [ 1 , 1 ]\end{matrix} ) ,$$

in which a comma is added to separate row and column indices for sub_matrices, and brackets are added to contain indices.

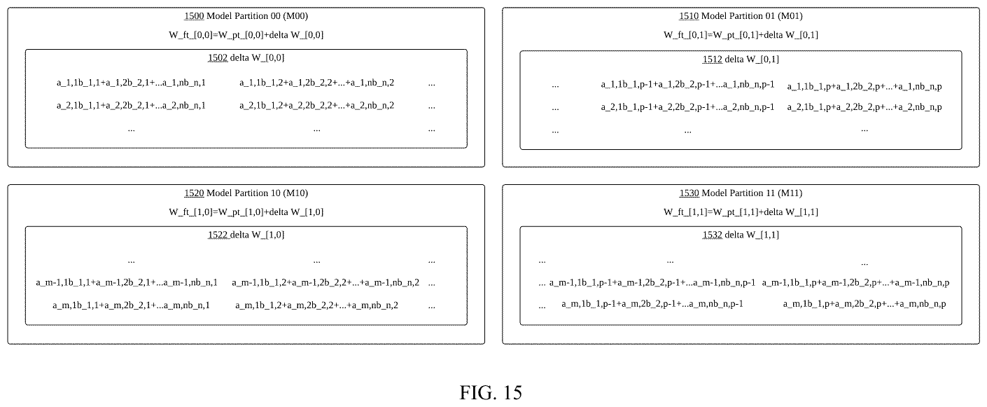

Second, partition matrices A and B, and place the partitions of A and B into GPUs that correspond to the same partition of W_pre_trained. FIG. 15 shows the correspondence. This is possible because in matrix addition, elements of the same row and column indices of W_pre_trained and delta W are added to form W_fine_tuned. Thus, the same model partition, or in this illustration the same quadrant, of W_pre_trained and delta W should be on the same GPU. W_fine_tuned and delta W are partitioned in the same manner as W_pre_trained. In FIG. 15, the model is partitioned into four partitions: model partition 00 (M00) 1500, model partition 01 (M01) 1510, model partition 10 (M10) 1520, and model partition 11 (M11) 1530. Because delta W is a dot product of A and B, each partition of delta W can be written in terms of a_i,j and b_i,j. FIG. 15 shows the partition of delta W_[0,0] 1502 and its corresponding a_i,j and b_i,j, and so forth for delta_W_[0,1] 1512, delta_W_[1,0] 1522, and delta W_[1,1] 1532. Those corresponding a_i,j and b_i,j in the same partition should be on the same GPU.

Partitioning of A and B should follow the corresponding partitioning of W_pre_trained. Specifically, following the quadratic partitioning of W_pre_trained, persons skilled in the art partition A and B as follows. A is partitioned into upper and lower sub_matrices as follows:

$$A = ( \begin{matrix}A\_ [ 0 , : ] \\ A\_ [ 1 , : ]\end{matrix} )$$

in which a colon denotes all rows or columns as in pytho, a comma is added to separate row and column indices for sub_matrices, and brackets are added to contain indices.
and B is partitioned into left and right sub matrices as follows:
B=(B_[:,0] B_[:,1]),
in which a colon denotes all rows or columns as in python, a comma is added to separate row and column indices for sub_matrices, and brackets are added to contain indices.

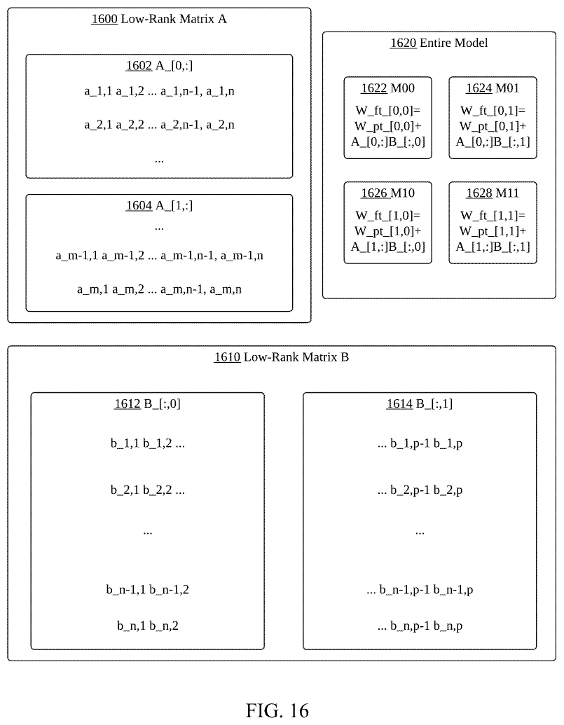

FIG. 16 shows a correspondence between partitions of the entire model 1620 and partitions of A 1600 and B 1610. A closer examination reveals that model partition 00 (M00) 1622 is only related to the upper half of A, A_[0,:] 1602, and the left part of B, B_[:,0] 1612; model partition 01 (M01) 1624 is related to A_[0,:] 1602 and B_[:,1] 1614; model partition 10 (M10) 1626 is related to A_[1,:] 1604 and B_[:,0] 1612; model partition 11 (M11) 1628 is related to A_[1,:] 1604 and B_[:,1] 1614. Conversely, A_[0,:] 1602 corresponds to M00 1622 and M01 1624; A_[1,:] 1604 corresponds to M10 1626 and M11 1628; B_[:,0] 1612 corresponds to M00 1622 and M10 1626; B_[:,1] 1614 corresponds to M01 1624 and M11 1628. Note that partitions of W_pre_trained are also on the same corresponding partitions of the model with sub_matrices of A and B, but are frozen. With the described partitioning of low-rank matrices A and B, the partitioned model's LoRA update formula still holds. That is, on model partition M00 1622, W_ft_[0,0]−W_pt_[0,0]+A_[0,:] B_[:,0]. Likewise, model partitions M01 1624, M10 1626, and M11 1628's respective LoRA update formulas are formulated similarly, as depicted in each model partition in FIG. 16.

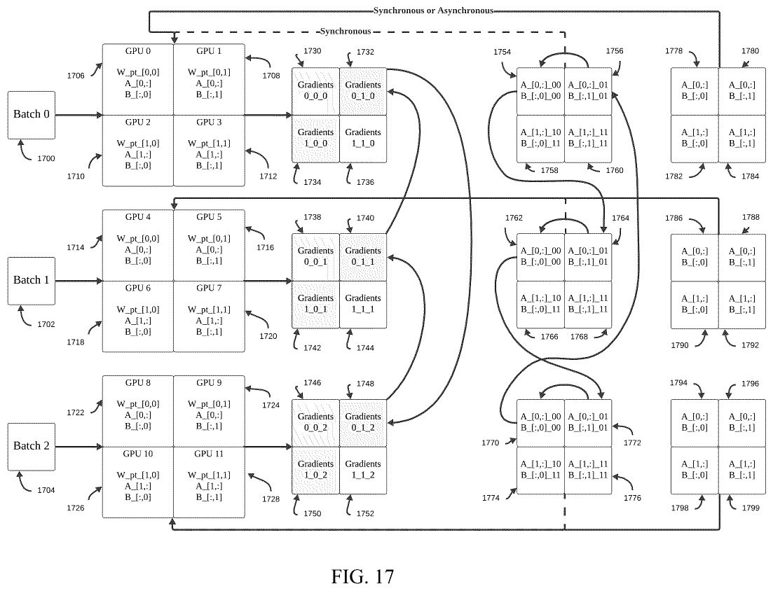

Third, apply ring-all reduce operations twice to obtain averaged weights of sub_matrices of A and B, as shown in FIG. 17. From left to right in FIG. 17, data batches 0 1700 to 2 1704 are input into GPUs. GPU 0 1706, GPU1 1708, GPU 2 1710, and GPU 3 1712 collectively have one copy of the entire model. On GPU 0 1706, there is the M00 partition of the entire model, which includes W_pt_[0,0], A_[0,:], and B_[:,0]; and similarly M01 on GPU1 1708, M10 on GPU2 1710, and M11 on GPU3 1712. Data batch 0 1700 is input into this copy of the entire model. Similarly, GPUs 4 1714 to 7 1720 have another copy of the entire model and data batch 1 1702 is input into that copy of the entire model, and data batch 2 1704 is input into GPUs 8 1722 to 11 1728. As a result, gradients are obtained for that specific model partition from that specific data batch on each GPU. For example, gradients 0_0_0 1730 (where the first two indices indicate the model partition and the third index indicates the data batch) are obtained for M00 from batch 0 1700 on GPU 0 1706.

By now, the partitioning of the model weights and the low-rank matrices is complete, and the partitions of model weights and corresponding sub_matrices of A and B are placed onto distributed computational units in a computational network. It is worth noting that distributed LoRA with data and model parallelism can be achieved now without ring-all reduce operations. Persons skilled in the art can use parameter servers to obtain the averaged sub_matrices of A and B without relying on ring-all reduce. In this disclosure, a method to use ring-all reduce, and optionally twice, is further described as follows.

The first ring-all reduce operation is applied across data batches to each of the corresponding model partitions' gradients to obtain averaged model partitions' gradients, and obviously across GPUs as well. For example, gradients 0_1_0 1732, gradients 0_1_1 1740, and gradients 0_1_2 1748 are all for the M00 model partition, but from batch 0 1700, batch 1 1702, and batch 2 1704 respectively. Their ring-all reduce operation results in the average gradients for the M00 model partition (omitted in FIG. 16). GPU1 1708, GPU 5 1716, and GPU 9 1724 each will have one identical copy of these averaged gradients for the M00 model partition. Then use these averaged model partitions' gradients to update each model partition's sub_matrices of A and B within a GPU in the same manner as the original LoRA does, noting that only sub_matrices of A and B are updated, since partitions of W_pre_trained are frozen. This is feasible because, on each partition, the LORA update formula (for example, W_ft_[0,0]=W_pt_[0,0]+A_[0,:]B_[:,0] for M00 1622) has the same formal structure as the original LoRA formula W_fine_tuned=W_pre_trained+AB. As a result, on GPU 1 1708, there are sub_matrices 1756 A_[0,:]_01 and B_[:,1]_01. The “01” at the end of the sub_matrices indicates that they came from the M00 model partition. Similarly, sub_matrices 1764 A_[0,:]_01 and B_[:,1]_01 on GPU 5 1716 and sub_matrices 1772 A_[0,:]_01 and B_[:,1]_01 on GPU 11 1728 are updated. Now, the weights of the sub_matrices of A and B on each GPU are updated. Two issues are worth pointing out: (1) Although sub_matrices 1756, 1764, and 1772 come from the same averaged gradients of the M00 model partition, due to stochasticity and other variances, they may not be exactly the same. (2) One sub_matrix of either A or B actually has multiple copies across model partitions. In this example, there are two copies each. For example, A_[0,:]_00 in sub_matrices 1754 from M00 on GPU 0 1706 and A_[0,:]_01 in sub_matrices 1756 from M01 on GPU 1 1708 have values that are not the same because they come from two different model partitions.

The second ring-all reduce is applied across GPUs to the same sub_matrices of A and B to obtain averaged weights for these sub_matrices. There are two ways to do so, both using ring-all reduce to get the average. (1) Persons skilled in the art can choose to ignore the variances of a sub_matrix across data batches and only average this sub_matrix across model partitions. In many use cases, with weight quantization and so on, these variances are negligible. For example, averaging A_[0,:]_00 in sub_matrices 1754 on GPU 0 1706 and A_[0,:]_01 in sub_matrices 1756 on GPU 1 1708 results in one averaged A_[0,:] on both GPU 0 1706 and GPU 1 1708. Another A_[0,:] on GPU 4 1714 and GPU 5 1716, and a third A_[0,:] on GPU 8 1722 and GPU 9 1724. This type of second ring-all reduce is not depicted in FIG. 16. (2) A more accurate but computationally and communication intensive approach is to average the same sub_matrix across all its copies with a ring-all reduce operation. For example, a ring-all reduce operation is applied to A_[0,:]_01 in sub_matrices 1756, A_[0,:]_00 in 1754, A_[0,:]_01 in 1764, A_[0,:]_00 in 1762, A_[0,:]_01 in 1772, and A_[0,:]_00 in 1770, to obtain the same averaged A [0,:] on GPU 0 1706, GPU 1 1708, GPU 4 1714, GPU 5 1716, GPU 8 1722, and GPU 9 1724. The sub_matrices of the same model partition will then have the same values. Sub_matrices 1778, 1786, and 1794 are the same for the M00 model partition. The same applies to sub_matrices 1780, 1788, and 1796 for M01, sub_matrices 1782, 1790, and 1798 for M10, and sub_matrices 1784, 1792, and 1799 for M11.

Fourth, update the model. Whenever sub_matrices of A and B are computed, they can be applied to the LoRA update formula to get W_fine_tuned. In this disclosure, the partitioned form of the LoRA update formula is used. (1) Persons skilled in the art can update the model after the first ring-all reduce operation, with different values of the sub_matrices of A and B. This update is indicated by the dashed arrows in FIG. 16. (2) Preferably, persons skilled in the art can update the model after the second ring-all reduce operation, with only one set of values for each of the sub_matrices of A and B. To keep the fine-tuned model the same across the computation network, it is preferred to update the model only after the second ring-all reduce operation. This update is indicated by the solid arrows from the rightmost to the left side GPUs in FIG. 16.

Then the obvious obstacle to updating only after the second ring-all reduce operation is that it is computationally and communication intensive. In data parallelism nomenclature, a step describes when all copies of the model take in their respective batch of data once. In FIG. 16, data batch 0 1700 into GPUs 0 1706 to 3 1712, data batch 1 1702 into GPUs 4 1714 to 7 1720, and data batch 2 1704 into GPUs 8 1722 to 11 1728 are collectively called one step. Thus, the number of data parallelism steps equals the number of data batches divided by the number of model copies. In one data parallelism step (defined the same in a ring-all reduce operation), the number of communications for a sub_matrix is the number of its copies across all partitions of the model times the number of model copies. For example, in FIG. 16, there are 6 peer-to-peer communications to get A_[0,:], because there are 2 copies of each sub_matrix and 3 copies of the model. The total number of communications is the number of communications per sub_matrix times the number of sub_matrices. In this example, as illustrated in FIG. 16, there are 4 sub_matrices, thus the total number of communications is 6*4=24.

On the contrary, in the first ring-all reduce operation, the number of communications for gradients of the same partition of the model is the number of model copies. In this example in FIG. 16, it is 3. The total number of communications is the number of communications per partition times the number of partitions per model. In this example in FIG. 16, there are 4 partitions of a model and 3 copies of the model, so the total number of communications is 4*3=12. The number of communications in the first ring-all reduce operation is usually much less than in the second ring-all reduce operation.

Persons skilled in the art can synchronize the two ring-all reduce operations and then perform a model update. Synchronized two ring-all reduce operations means that in each data parallelism step, after the first ring-all reduce operation, the second ring-all reduce operation follows. This solution inevitably faces the heavy computation and communication problem in the second ring-all reduce operation.

Alternatively, persons skilled in the art can perform the two ring-all reduce operations asynchronously and update the model only after completing the second ring-all reduce operation, thereby reducing communication overhead during the second ring-all reduce operation. After completing the first ring-all reduce operation in a given data parallelism step, the resulting sub_matrices of A and B can be saved locally on their respective GPUs. The second ring-all reduce operation can then be temporarily deferred. In subsequent data parallelism steps, each subsequent first ring-all reduce operation produces its own copies of sub_matrices of A and B, which are similarly saved locally. After a certain number of data parallelism steps, the locally stored sub_matrices of A and B are averaged on their respective GPUs without requiring a ring-all reduce operation. Once this local averaging is completed, the second ring-all reduce operation can be performed.

This solution defers the second ring-all reduce operation during intermediate data parallelism steps, executing it only after a sequence of first ring-all reduce operations, which significantly reduces the communication cost associated with the second ring-all reduce operation. The number of first ring-all reduce operations performed before each second ring-all reduce operation can be fixed or determined from a random distribution, providing flexibility in optimizing overall communication cost.

In practice, persons skilled in the art can weigh the pros and cons to choose among the solutions described in this section. To choose ring-all reduce operations with LoRA on top of both data and model parallelism, the model might be so large that even the low-rank matrices A and B used in LoRA cannot fit into one computation unit, but the communication cost is low.

Here, the flexibility in the partitioning of LoRA is elaborated on. In the example partitioning described in detail in this disclosure, the matrix W_pre_trained is partitioned into four sub-matrices, and the low-rank matrices A and B are partitioned, accordingly into two sub-matrices each, based on the partitioning of W_pre_training. In fact, the partitioning of W_pre_trained can be adjusted based on the requirements of the computational network and arranged in various other configurations. Each corresponding sub-matrix of the dot product of A and B, defined by the corresponding row and column indices of W_pre_trained, can always be represented as the result matrix of operations performed on sub-matrices of A and B. The low-rank matrices of A and B are partitioned to ensure that the resulting matrices match the required corresponding sub-matrices of the dot product of A and B. One sub-matrix of W_pre_trained and its corresponding sub-matrices of low-rank matrices A and B are copied into the same computational unit. This arrangement allows the distributed LoRA with model parallelism to function effectively, optionally incorporating data parallelism, and optionally again incorporating one or more ring-all reduce operations in a data parallelism step.

In this disclosure, GPUs are mentioned as the most common computation units on a network. This disclosure focuses on the method of ring-all reduce gradient update on top of both data and model parallelism. The exact devices used on the computation units of a network can be flexible. CPUs, quantum computing units, and many other devices can be used.

Section 5.2. Generic Visual 2D or 3D Chart Generation with a Hybrid Large Language Model Via a Generic Language Representation, a Graph Representation, or Both

Many web, cloud, or standalone computer applications are used to generate some types of visual charts. For example, in a PowerPoint presentation, each slide is like a canvas, and each icon, background, or text area is a visual element. So basically, each PowerPoint slide is a visual chart. The same applies to Lucidchart's charts, BioRender's illustrations, Figma's user interface mock-ups, hardware design applications, floor plan design applications, CAD applications, 3D printing applications, and the visual interfaces of web pages, especially those types of web pages that can be created by drag-and-drop applications like Wix. All these different applications are written in their respective computer languages. Web pages or user interfaces are written mostly in JavaScript and HTML, PowerPoint in office_java script and office visual basic, CADs in hardware description language, and so on. A common approach would be to fine-tune existing large language models on computer code in their respective specific languages that generate these visual charts, having tasks such as predicting tokens for that particular computer language or generating computer language code with a historical prompt or with the visual charts' historically accompanying texts. Examples of those solutions would be generating JavaScript and HTML code for web pages or generating office_java script and visual basic code for PowerPoint files. This common solution works with historical data, because existing PowerPoint files or web pages are written in separate computer languages. However, this common solution lacks a certain degree of generalization for visual elements. Persons skilled in the art would probably prefer to have individual fine-tuned models for each computer language and their associated types of visual charts. This solution also suffers from the limitation of language problems: the organization of tokens is usually sequential and either uni- or bi-directional.

Various embodiments of this disclosure provide a generic solution for the generation of 2D or 3D visual charts via a common language representation such as JSON, YAML, and so on.

Steps are described as follows. First, translate the 2D or 3D visual chart (whether bitmap or vector-based) into a common language representation such as json, yaml, and so on. For example, a canvas or background could be represented by 2D axis values, and a spatial background by 3D axis values in json. A visual element could be represented by its values in type, color, location, size, associated text, etc. For example, this json is a simple representation of a rectangular box with text in it, and a canvas: {“canvas”: {“x_axis”: 150, “y_axis”: 200, “canvas_shape”: “rectangular”}, “element_array”: [{“element_id”: 1234, “element_category”: “shape”, “element_sub_category”: “rectangle”, “element_properties”: {“color”: 206, “location_x”: 100, “location_y”: 80, “display_text”: “hello world”, “length”: 20, “height”: 30, “connected_element_id_array”: [{“element_id”: 1430, “edge_relationship”: “contain”}, {“element_id”: 840, “edge_relationship”: “point_to”}]}}]}. Notice that some of the element's properties represent a graph relationship among different elements, such as “to_connected_element_id_array”. If historical visual charts are written in other computer languages and have computer code, persons skilled in the art can write code to output corresponding json files to represent the same visual charts. If historical visual charts do not have code, but are hand-drawn or only have PNG files, first perform visual object detection to identify visual elements and their properties, then organize them into the said json file. Those json files, which constitute natural language corpora, are used for fine-tuning existing large language models.

Next, in many types of charts, the lowest-level visual elements are predefined. For example, in Lucid chart, an icon is among the lowest-level of elements. So in addition to defining tokens as natural language tokens from the json file, the lowest-level visual element should have its own token and corresponding embedding. For example, if there are only two elements, “rectangle” and “circle,” each of them should have its own token and embedding, such as [01] for “rectangle” and [10] for “circle” in a one-hot embedding. Persons skilled in the art can use more appropriate embeddings, such as embeddings of vertices from the graph itself. Persons skilled in the art can choose other appropriate encoding methods for tokens too. For example, a sequence of [“rectangle”, “rectangle”, “circle”] should be [[01], [01], [10]]. If it is processed as a language problem (which is not the main purpose of the proposed method in this disclosure, but can be kept as redundancy), the sequence's token representation could be [“rect”, “angle”, “rect”, “angle”, “circ”, “le”] and its corresponding language-encoded token sequence. How the visual elements form this sequence will be discussed later in this section.

Next, in many types of charts, various degrees of lowest-level visual elements are usually grouped together. Those grouped elements are often used repeatedly in the charts and should be treated as tokens too. To choose the appropriate level of grouping, persons skilled in the art could utilize techniques similar to those in natural language processing (NLP), such as byte pair encoding. For example, if two attached circles always appear together repeatedly but not three circles or rectangles, they should form a new element “adjacent_two_circle”.

Next, persons skilled in the art serialize visual elements when they are not represented in the json file's natural language format. Visual elements and their relationships can be described by graphs. Elements are vertices, and their relationships are edges. Persons skilled in the art can find all the paths on the graph to form sequences that cover all elements on the graph. Optionally, persons skilled in the art can trim the number of paths with a preference for longer paths to cover as many elements as possible. Those paths form the new corpus at the visual element level. This is also the reason this disclosure is reluctant to call Section 5.2 a multi-modal approach, but rather a hybrid approach. Although encoding visual elements is very similar to multi-modal approaches, the serialization is not done as in multi-modal approaches by simply cutting the picture into grids as tokens and using a convolutional neural network (CNN) embedding for token embedding, going from top-left to bottom-right order as positions for sequences. In this disclosure, this traditional multi-modal approach for the image will be called image CNN modality. However, this disclosure uses graph techniques to organize the visual element tokens into sequences. In this disclosure, this technique will be called the visual graph modality. This disclosure will still call the json representation of charts as sequences of natural language tokens the natural language modality. In this disclosure, natural language modality and visual graph modality are two distinct modalities in the corpus.

Next, organize the two-modality input and model structure for visual chart generation, given the fact that by the time this disclosure is written, existing multi-modal models support image CNN modality and natural language modality, but not the visual graph modality.

In the first embodiments, if persons skilled in the art want to make minimal changes to the existing foundation large language models, including weights, tokens, encoding, and model structures, only the generic language representation files such as json files, their related prompts, and related natural language materials will be in the corpus, for continuous training, fine-tuning, and so on of the existing foundation large language models without changing the structure of the model at all. Alternatively, persons skilled in the art can add adaptor layers to the existing foundation large language models to freeze the existing model layer weights, but learn new tasks with learnable weights in the adaptor layers. Tasks focus on generating the generic language representation files such as json files. This solution maps visual charts into natural language.

In the second embodiments, if persons skilled in the art want to make use of the visual graph modality, more changes to the model structure are needed. If persons skilled in the art do not want to keep the trained weights in the existing large language model, they can begin training a brand-new model with brand-new model structures, from corpora with the natural language modality and visual graph modality. Attentions for different modalities, multi-head attention within a modality, location encoding for different modalities, cross-modal attentions, and other appropriate techniques can be added. When the edge relationship for visual elements is unidirectional, persons skilled in the art could use unidirectional attention. When the edge relationship for visual elements is bidirectional, persons skilled in the art could use bidirectional attention with absolute position encoding. For example, visual elements A<->B<->C<->D form a bidirectional path on a graph. Absolute position for element A is 0, B is 1, C is 2, and D is 3 (zero-indexed), and attention can be bidirectional. Optionally, persons skilled in the art can treat this path as two sequences: (1) A->B->C->D with A as 0, B as 1, C as 2, and D as 3 (zero-indexed), using unidirectional attention, and (2) D->C->B->A, with D as 0, C as 1, B as 2, and A as 3 (zero-indexed), also using unidirectional attention. As deep learning models, including transformer models, are extremely flexible, persons skilled in the art can choose appropriate model structures and implementations for their specific use cases.

Alternatively, in the third embodiments, persons skilled in the art can keep the pre-trained weights in the existing large language model, but still add the visual graph modality. They can take advantage of the pre-trained weights to perform a multi-modal expansion. The new model structure modularizes the language modality with the existing large language model's structure. Persons skilled in the art can take advantage of the model structure and weights updated with previous embodiments (the mapping to json solution) mentioned in 00271. Those weights can be frozen, or at least used as the initial weights to begin subsequent training. The new model structure also modularizes the visual graph modality with a newly added transformer-like model structure, since the visual graph modality has already been transformed from a graph of vertices into sequences of tokens, and this sequence representation of the visual graph modality is more appropriate for a transformer-like model structure. The modularized model structure of the visual graph modality module can have its own multi-head attention for this modality, position encoding for this modality, and so on. The modularized model structure of the visual graph modality can be trained from scratch. Then add fusion layers. Persons skilled in the art can introduce layers that fuse different modalities in the model, for example, using cross-modal attention mechanisms to combine new modality representations with language representations. These newly added layers can be trained from scratch while keeping the original language model part unchanged or fine-tuned.

After the generic language representation, graph representation, and/or a hybrid of language and graph representation of visual charts are generated, mechanisms are first needed to check if the representation actually forms a legitimate visual chart. This is similar to when an LLM generates python code and one must first check whether this generated python code can run in a python executor; or if an LLM generates SQL code, one must first check whether the generated mySQL code can run on a SQL server. Persons skilled in the art will build services to map the representation to a visual chart and display the visual charts, and then verify whether the LLM-generated representation in this disclosure displays visual charts in such services. Second, there will be a scoring model or human feedback to check if the generated charts meet higher-level requirements, such as the logic of the relationships among elements, the aesthetics of the charts, whether the charts match the prompts' instructions, the creativity of the charts, the truthfulness of the charts, and so on. Further human and/or scoring model feedback reinforcement learning would be applied to further adjust the weights of the optionally hybrid LLM.

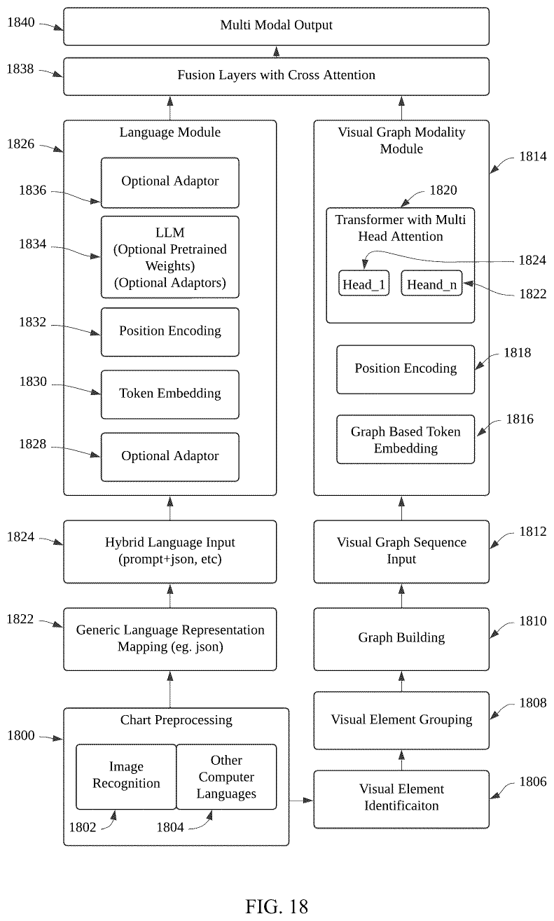

FIG. 18 illustrates an example of the third embodiments with the ideas of the first embodiments incorporated into it as a whole. The second embodiments can train from scratch using a model structure similar to those in FIG. 18 or different structures. A major change for the second embodiments could be not using modular structures, but building cross-modal attentions and position encoding at the same time. Please note that deep learning models, including transformer models, are extremely flexible. Persons skilled in the art can add more modalities and their corresponding modules, change layers within modules, change types and numbers of attentions, use uni- or bi-directional attention, and change all aspects of heads, and so on. Thus, the exact structure of the model is not limited to this particular example.

FIG. 18 starts from the bottom left. Chart preprocessing 1800 utilizes image recognition 1802 and/or other computer languages 1804. On the left side is the language modality path. On the right side is the visual modality path. On the language modality path, chart preprocessing 1800 maps charts to generic language representations such as json at 1822. Natural language prompt, natural language corpus, and json corpus become a hybrid language input 1824 to a language module 1826 of a visual chart generation model, which consists of a language module 1826, a visual graph modality model 1814, and fusion layers 1828. The language module 1826 could optionally contain a previously existing LLM 1824 with optional pre-trained weights and optional hidden adaptor layers. Optional adaptor layers can be added prior to the previously existing LLM at 1828, and optional adaptor layers can be added after the previously existing LLM at 1836. The language input follows the same token embedding 1830 and position encoding 1832 as required by the LLM 1834.

On the visual graph modality path, visual elements with arrows and links that can represent edges, and shapes and icons that can represent vertices, are identified at 1806. Repeated grouping of visual elements is performed at an appropriate level 1808. A graph for the edges and vertices is built, and embeddings of vertices are calculated based on the graph 1810. Paths on the graph form sequences of input at 1812 to the visual graph modality module 1814. Token embedding 1816 follows the graph embedding, and position embedding follows the graph-based sequences at 1818. A dedicated transformer-structured module 1820 is used to model the visual graph modality, with multi-head attention (head 1 1824 to head n 1822). A fusion layer with cross-modality attention 1838 is added after the previous two modules. The model outputs are multi-modal with natural language, language representations of visual charts, and graph representations of visual charts.

Although this disclosure focuses on chart generation, it does not limit the modalities to only language and visual graphs. Some charts contain images, so an image modality path can be added in parallel to the model structure, and other modalities as well.

When this hybrid modality chart generation model is used for new chart generation, the prompt input can contain not only the natural language prompt, but also graph-based information in the prompt. A detailed discussion on a novel way of using graphs for information retrieval will be discussed in Section 5.3. This retrieved information will be used as prompt input.

### Section 5.3 Graph Modality Enabled Generation

Traditional LLM's retrieval augmented generation (RAG) use language embedding similarities (the opposite of distances) to retrieve chunks of natural language that are most relevant to the natural language queries in the generation step. Then, persons skilled in the art feel that traditional RAG lacks the connectivity of the chunks, so a natural-language-based graph RAG approach, notably whose concept was popularized by Microsoft and whose pipeline was developed by LlamaIndex, has evolved from the traditional RAG. In natural-language-based graph RAG, at the find similarities (retrieval) step, it is based on a graph; however, in the generation step, it only utilizes the natural language property of the retrieved nodes and puts those retrieved natural language pieces into the prompt for generation. For example, if movie ids are vertices on a graph, and each movie id has properties like synopsis, plot, plot summaries, directors, genres, etc., that are in natural languages. In the natural language based graph RAG, in the retrieval stage, a natural language prompt query may be mapped to a movie id cluster center, or a particular movie id, to retrieve all the movie ids in that cluster, or the top K movie ids closest to the particular movie id mapped from the query. In the generation step, the natural language based graph RAG can only use those retrieved movie ids' natural language properties to generate natural language responses. For instance, if the query is “summarize Tom Cruise's adventure movies,” it will find the cluster of Tom Cruise, find all his adventure movie ids, and summarize plot or synopsis depending on specific prompt instructions. The natural language based graph RAG cannot input movie ids (as vertices) in the prompt and generate sequences of movie ids (sequences of vertices). The fundamental reason for the lack of generation based on the rich connection among vertices on a graph is that the generation models in language based graph RAG only have the natural language modality.

Meta's concept of Transformers4Rec treats item ids as tokens. However, those item ids in Transformers4Rec only form sequences, with no graph to describe those tokens' complicated relationships. In reality, for recommendation systems, the relationships for item ids are not just the next item in the sequence. Transformers4Rec only switches from recurrent neural networks to a transformer to generate the next item in the sequence. For example, Tom Cruise's movies in the adventure genre can be chronologically ordered, forming a next-item sequence in Transformers4Rec. However, Tom Cruise's movies may share some similarities with other adventure movies such as the Bourne Identity or John Wick, whose relationship with Tom Cruise's movies can form edges on a graph but would be very hard to capture in the next-item sequence. If, in the training data, very few or no users have watched Tom Cruise's movies along with John Wick's movies, despite many other similarities a graph might have found among them, a sequence-only approach without a graph layer would be hard-pressed to generate the next item that mixes Tom Cruise's and John Wick's movies.

Various embodiments of this disclosure provide a new graph modality enabled generation method, not limited to graphs dedicated only to visual charts in Section 5.2, but also applicable to graphs for any types of vertices, such as movie ids, item ids, academic ids. The transformer-based model, similar to the visual graph modality module 1514, inputs sequences of vertex ids and outputs sequences of next vertex ids. The difference between this disclosure's proposed graph enabled generation and the previous natural language based graph RAG is that the graph enabled generation produces vertex ids, a capability the previous natural language based graph RAG lacks. The difference between graph enabled generation and Transformers4Rec is that graph enabled generation uses graph paths to generate sequences, which encompass much richer connectivity among tokens than the sequential order-only approach.

The applications of the graph modality enabled generation can be very large. It is not limited to the following examples. They could be action sequences for AI enabled agents in price negotiation, law, tax strategy, etc., where actions can be vertices; they could be recommender systems for items such as products in e-commerce, movies, articles, ads, videos, etc.; they could be generation of visual charts or 3D models.

For action sequence generation in AI agents, one already has actions on the graph as vertices. Given an action taken, the goal is to find another action. In the past, when there was only the graph, the problem became finding the nearest or next neighbors of the vertex that represent the given action, or the path to a goal vertex. Now, with transformer generated vertex sequences, given the sequence of past action vertices, given a prompt of the natural language goal, given a prompt of the goal vertex, given the natural language properties of the action and goal vertices and other prompts, the model can generate the next action vertex sequence. For recommender systems, persons skilled in the art can borrow Transformers4Rec's idea and use the next items (vertices) as recommended items. For chart generation, the methods are described in Section 5.2 in detail.

### Section 5.4 Picture Generation Enabled Search and Drop Ship

A user might search for a “backless twirling dress” which returns items that either belong to the group of backless dresses but have a narrow skirt or a bodycon bottom, or twirling skirts or dresses that fully cover the back. The reason is that the dresses in the search results do not actually have a combination of these two properties, which constitute the majority of available dresses on the internet. Probably the only dress that matches the search query is actually called a “Cinderella” dress on its seller's web page, on which its description has no natural language mention of the dress being backless or twirling, but rather a romantic citation of the fairy tale and how this dress could change the life of the woman who wears it.

Given that the existing internet has a rich database of dress pictures, each having either the “backless” or the “twirling” property, persons skilled in the art can first use CNN to label these properties. Then they can make a multi-modal large model with natural language (natural language properties of the image plus other corpus) and image modalities to generate images of a dress that possesses both properties, allowing the user to select the one they prefer. Subsequently, an image-to-image search based on CNN similarities can be performed to find the matching dress, even if the existing natural language description does not contain keywords related to the properties. If no similar dresses can be found, a drop ship service system can step in to make a custom-ordered dress.

Clearly, the proposed solution is not limited to dresses. Any merchandise, such as cars, furniture, etc., can utilize picture generation enabled search and drop ship to enhance product discovery and shopping experiences. Drop ship refers to a retail fulfillment method where there is no inventory and products are made on demand once a costumer places an order. Steps are: (1) image property recognition: partition merchandise images, label the partitioned image properties in natural language, and use CNN or other models to output the image part's properties in natural language; (2) multi-modal model training with images and their natural language properties and other natural language corpus in the training data; (3) generate product images based on the user's natural language query; (4) do additional image-to-image searches to enhance the search results; (5) make a drop ship service to satisfy user demand if customers are not satisfied with the search results.

### Section 5.5 EquiFormer Incorporated Multi Modal Car Foundation Model

Persons skilled in the art recognize that cars are a special example of equipment in the framework of EquiFormer. In FIG. 1, part of the function of a car driver is to be the hardware admin 154, and the automated driving system can incorporate the EquiFormer system, especially one in which the layered model structure can forecast into a more distant future, providing the system and the human driver additional reaction time beyond an immediate next intervention. Persons skilled in the art also recognize that the current form of the EquiFormer system in this disclosure focuses on controlling hardware through a network of cars and models, but lacks interaction with other human admins, drivers, pedestrians, passengers, and so on. Road conditions, weather conditions, and so on are already incorporated as input into the EquiFormer system.

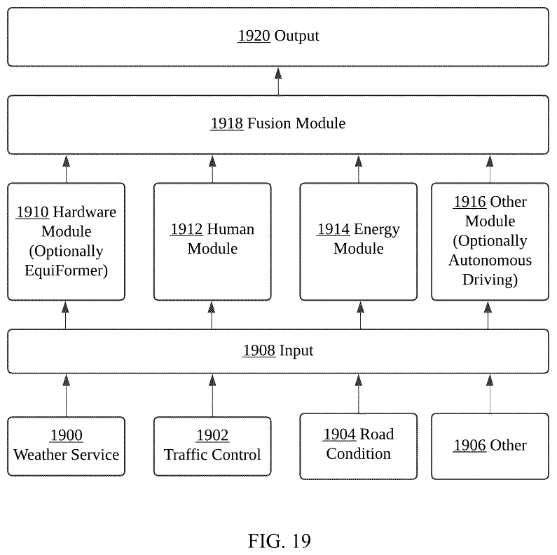

In Section 5.5, this disclosure proposes that a large car foundation model should have a hardware equipment network module, a human behavior network module, an energy module, and so on, in a structure similar to FIG. 18, having multi-modality modules and then fusing them together, with the EquiFormer model structure as the backbone of the hardware module of the large car foundation model. FIG. 19 depicts a car conceptual multi-modal modularized foundation model. It contains weather services 1900, traffic control 1902, road conditions 1904, and other input-related services 1906. They contribute to the input 1908 to the car foundation model, which consists of a module for hardware 1910 in which an EquiFormer-like structure could be used, a human module 1912, an energy module 1914, and other modules 1916 that could optionally include an autonomous driving module. Inside the hardware module 1910, there could optionally be dedicated sub-modules for different types of cars, such as internal combustion engine vehicles, hybrid vehicles, extended range electric vehicles, all electric vehicles, and hydrogen powered vehicles, especially if within this module non-transformer-based modeling techniques are used. If a transformer-based “large” model is preferred in the hardware module, those types of cars should be treated like languages in an LLM, all built into the transformer model structure.

What is claimed is:

1. A method for controlling hardware, comprising:
obtaining equipment sensor data from a plurality of sensors in a first time series;
obtaining equipment optimization goal data from a plurality of optimization goals in a second time series;
obtaining historical data on equipment abnormal events and intervention actions;
obtaining static equipment input parameters;
applying time series models to the obtained equipment sensor data, the historical data on equipment abnormal events and intervention actions, and the static equipment input parameters, to obtain predicted equipment sensor data, predicted optimization goal values, and predicted abnormal events; and
providing predicted intervention actions for abnormal event intervention based on: the obtained static equipment input parameters, the obtained equipment sensor data, the obtained equipment optimization goal data, the predicted equipment sensor data, the predicted optimization goal values, and the predicted abnormal events;
wherein said applying further comprises applying a machine learning architecture including stacking two or more layers of models on top of the obtained equipment sensor data, the historical data on equipment abnormal events and intervention actions, and the obtained static equipment input parameters;
wherein the two or more layers of models comprise the predicted equipment sensor data, the predicted optimization goal values, the predicted intervention actions, and the predicted abnormal events; and
wherein said providing comprises sending a control signal based on the predicted actions to a control circuit for controlling the hardware to modify a manufacturing process toward the predicted optimization goal values and to intervene the predicted abnormal events.

2. The method of claim 1, further comprising:
iterating at least once between said obtaining historical data on equipment abnormal events and intervention actions, said obtaining static equipment input parameters, and said applying the time series models; and
providing the predicted intervention actions to a user based on results from said iterating.

3. The method of claim 2, wherein
said providing further comprises displaying the results on at least one of a display screen, providing an Application Programming Interface (API) to control the hardware, or providing a phone alert to the user; and
the method is implemented by a hardware control system configured to:
(1) generate hardware control signals from the input from the layered machine learning models and the current operating state of equipment, thereby altering the state of equipment operation;
(2) execute optimization strategies by maintaining the hardware at optimal operating parameters in real-time or through scheduled adjustments to achieve predicted optimization goal values; and
(3) execute predicted abnormal event intervention actions by preemptively altering equipment operations to prevent or mitigate the impact of predicted abnormal events.

4. The method of claim 1, further comprising:
outputting, from the time series models, the obtained equipment sensor data y_(si-t), from i-th sensor, as a function of time t;
wherein the obtained equipment sensor data y_(si-t) comprise temperature data measured at specified locations; and
wherein the obtained equipment sensor data y_(si-t) comprise at least one of amplitude, voltage, current, frequency, or force of an electric motor.

5. The method of claim 1, further comprising:
outputting, from the time series models, the obtained equipment optimization goal data y_(oj-t), from j-th optimization goal, as a function of the time t;
wherein the obtained equipment optimization goal data y_(oj-t) comprise at least one of energy output, power, torque, or energy efficiency of an electric motor.

6. The method of claim 1, further comprising generating a target value sequence beyond one time stamp ahead, and use the generated target value sequence for models in downstream layers as input when real data are not available.

7. The method of claim 6, further comprising constructing an abnormal event models in a second layer among the two or more layers, wherein the abnormal event model predicts predicted abnormal events far into the future facilitated by that:
a first layer among the two or more layers is capable to predict equipment sensor data far into future resulting from that the first layer comprises the predicted equipment sensor data, and the predicted optimization goal values; and
manipulation of historical abnormal event data is by rows, enabled by choice of survival classifiers, to overcome lesser historical abnormal event label in a supervised learning concept.

8. The method of claim 1, wherein the time series models comprise a transformer model.

9. The method of claim 8, wherein:
the abnormal event model is based on a transformer model that is capable to forecast the predicted abnormal events when there are many historical abnormal events;
the transformer model is configured to forecast the predicted abnormal events when there is no previous historical abnormal event;
the transformer model is configured to forecast the predicted abnormal events when there is only one previous historical abnormal event; and
the transformer model is configured to forecast the predicted abnormal events when there are several previous historical abnormal events.

10. The method of claim 8, further comprising constructing an action recommendation model configured to output the predicted actions far into the future from the transformer model.

11. The method of claim 8, further comprising:
providing hardware equipment parameter optimization base on the transformer model, wherein the transformer model comprises a foundation model configured to learn and organize hardware equipment data from a plurality of use cases and types of equipment and a plurality of input and output data types and sources.

12. The method of claim 3, further comprising:
providing an EquiFormer system design based on a network of connected equipment including remotely configurable and programmable optical programming processors with configurable parameters from both the equipment sensor data and the machine learning architecture;
wherein the remotely configurable and programmable optical programming processors comprise a remote switch, a communication component, and a control component with rewritable storage of new parameters and programmable chips for programming control, and a signal converting component configured to convert model parameters into light signals; and
wherein when the network is available, the communication component is configured to have a two-way communication with the machine learning architecture to reconfigure the configurable parameters.

13. The method of claim 12, wherein when the network is offline, the method further comprises:
sending the configurable parameters based on light wave or photon communication unilaterally from the machine learning architecture to photon controlled optical programming processors;
wherein the light wave or photon communication spans a distance between Earth and space.

14. The method of claim 13, further comprising a blockchained quantum network for generic quantum bit communication;
wherein blockchained refers to a blockchain-like mechanism that transmits quantum bit encoded information from an initial source block to subsequent chained blocks;
wherein quantum refers to the minimum discrete values of a physical property including light.

15. The method of claim 8, further comprising ring-all reduce operation on top of model and data parallelism for deep learning model training including transformers and/or low-rank adaptation;
wherein:
low-rank adaptation, low rank matrices A and B are further partitioned in to sub matrices and put on to the same computation units with their corresponding partitions of a deep learning model; or
parameter servers can be applied to obtain averaged sub matrices of A and B for low-rank adaption; or
single or dual ring-all reduce operations can be applied to obtain the averaged sub matrices of A and B for low-rank adaption.

16. The method of claim 8, further comprising 2D or 3D chart generation with large language models via at least one of generic language representation or visual graph modalities.

17. The method of claim 16, further comprising a fusion transformer model of language modalities from existing large language models and graph modalities.

18. The method of claim 16, further comprising graph vortex identification sequence retrieval and generation with transformers, and use for AI agents, action sequences, recommendations.

19. The method of claim 8, further comprising a language and image multi-modal large model generated picture enabled search and drop ship system.

20. The method of claim 16, further comprising a multi modal car foundation model.
